(19) United States
(12) Patent Application Publication
(10) Pub. No.: US 2026/0003032 A1
(43) Pub. Date: Jan. 1, 2026

(54) SPATIAL CONFIGURATION METHOD, ELECTRONIC DEVICE

(71) Applicant: LUMI UNITED TECHNOLOGY CO., LTD., Shenzhen (CN)

(72) Inventors: Yang HAN, Shenzhen (CN); Zhaoze ZENG, Shenzhen (CN); Yujing MENG, Shenzhen (CN)

(73) Assignee: Lumi United Technology Co., Ltd., Shenzhen, GD (CN)

(21) Appl. No.: 19/321,344

(22) Filed: Sep. 8, 2025

Related U.S. Application Data
(63) Continuation-in-part of application No. PCT/CN2024/080414, filed on Mar. 6, 2024.
(63) Continuation-in-part of application No. PCT/CN2024/082311, filed on Mar. 18, 2024.
(63) Continuation-in-part of application No. PCT/CN2024/082813, filed on Mar. 20, 2024.
(63) Continuation-in-part of application No. PCT/CN2024/082821, filed on Mar. 20, 2024.

(30) Foreign Application Priority Data
Mar. 6, 2023 (CN) 202310205584.5
Mar. 20, 2023 (CN) 202310270464.3
Mar. 20, 2023 (CN) 202310292511.4
Mar. 20, 2023 (CN) 202310313227.0

(51) Int. Cl. G01S 7/06; G01S 13/72; H04L 12/28

(52) U.S. Cl. CPC G01S 7/06; G01S 13/72; H04L 12/282

(57) ABSTRACT

The present disclosure relates to a spatial configuration executed by an electronic device, includes: obtaining trajectory information of a first target object within each space of a target space, generating and displaying a trajectory diagram for each space based on the trajectory information, the trajectory information indicating movement trajectories of the first target object in each space; marking an entrance and exit position of each space on the trajectory diagram of each space, and matching marked entrance and exit positions with the trajectory diagram of each space to obtain a spatial layout diagram corresponding to the target space.

The present disclosure is a Continuation in-part of International Patent Application No. PCT/CN2024/082813, filed Mar. 20, 2024; International Patent Application No. PCT/CN2024/080414, filed Mar. 6, 2024; International Patent Application No. PCT/CN2024/082311, filed Mar. 18, 2024; and International Patent Application No. PCT/CN2024/082821, filed Mar. 20, 2024. Each of these international applications claims priority to, respectively: Chinese Patent Application No. CN2023102704643, filed Mar. 20, 2023; Chinese Patent Application No. CN2023102055845, filed Mar. 6, 2023; Chinese Patent Application No. CN2023102925114, filed Mar. 20, 2023; and Chinese Patent Application No. CN2023103132270, filed Mar. 20, 2023. The entire contents of all the foregoing applications are incorporated herein by reference.

### TECHNICAL FIELD

The present application relates to the technical field of the Internet of Things, more specifically, the present application relates to a spatial configuration method and an electronic device.

### BACKGROUND

With the continuous development of the Internet of Things (IoT) field, smart devices may be deployed in various scenes; for instance, the scene may be a smart-home scene, so as to provide users with device control services for each smart device within the scene, thereby enabling users to enjoy a more comfortable living, studying, or working environment; this also leads users to pay increasing attention to how to better monitor each smart device within the scene, so as to adjust the environment in a timely manner.

In current device monitoring schemes, users are unable to obtain a spatial layout diagram of the smart home scene and therefore may not intuitively monitor the corresponding smart devices, thus affecting the effectiveness of the device control services.

From the above, it may be seen that the related art still lacks a solution for intuitively monitoring a scene, which in turn affects the effectiveness of the device control services.

### SUMMARY OF THE DISCLOSURE

The present disclosure relates to a spatial configuration method and an electronic device.

Based on one aspect of the present application, a spatial configuration method, executed by an electronic device, includes: obtaining trajectory information of a first target object within each space of a target space, generating and displaying a trajectory diagram for each space based on the trajectory information, the trajectory information indicating movement trajectories of the first target object in each space; marking an entrance and exit position of each space on the trajectory diagram of each space, and matching marked entrance and exit positions with the trajectory diagram of each space to obtain a spatial layout diagram corresponding to the target space.

Based on one aspect of the present application, a spatial configuration method, executed by an electronic device, includes: displaying a spatial configuration page; the spatial configuration page including a spatial region; the spatial region including a region from a spatial layout diagram corresponding to a target space, the spatial layout diagram is obtained from trajectory information of a first target object within each space of the target space and an entrance and exit position of each space, the spatial layout diagram also displaying previously added second target objects at corresponding positions; displaying, in a scheme presentation area of the spatial configuration page, a device control scheme, the device control scheme is generated by matching relationships among second target objects in the target space; in response to a save operation on a selected device control scheme, generating an intelligent space template based on the device control scheme, the intelligent space template is configured for match application to spaces compatible with the target space.

Based on one aspect of the present application, an electronic device includes at least one processor and at least one memory, wherein the memory stores computer readable instructions; when executed by one or more of the processors, the computer readable instructions implement the spatial configuration method described above.

Based on one aspect of the present application, a computer readable storage medium has computer readable instructions stored thereon; when executed by one or more processors, the computer readable instructions implement the spatial configuration method described above.

Based on one aspect of the present application, a computer program product includes computer readable instructions; when executed by a processor, the computer readable instructions implement the spatial configuration method described above.

### BRIEF DESCRIPTION OF THE DRAWINGS

In order to more clearly illustrate the technical solutions provided by the present application, the accompanying drawings to be used in the description of each embodiment of the present application are briefly introduced below.

FIG. 1 is a schematic diagram of an implementation environment involved in an embodiment of the present application.

FIG. 2 is a flowchart illustrating a spatial configuration method of an exemplary embodiment.

FIG. 3 is a schematic diagram illustrating the generation process of a spatial layout diagram corresponding to a target space of an exemplary embodiment.

FIG. 4 is a schematic diagram of a spatial layout diagram corresponding to a home furnishing scene of an exemplary embodiment.

FIG. 5a is a schematic diagram of an environmental model of a home furnishing scene of an exemplary embodiment.

FIG. 5b is a schematic diagram of an environmental model of a home furnishing scene of another exemplary embodiment.

FIG. 6 is a schematic diagram of a region editing page in the spatial configuration method provided by an embodiment of the present application.

FIG. 7 is a schematic page diagram of configuration options in a region configuration page provided by an embodiment of the present application.

FIG. 8 is an exemplary diagram of an edge attribute configuration page provided by an embodiment of the present application.

FIG. 9 is a schematic diagram of a prompt information display page provided by an embodiment of the present application.

FIG. 10 is a schematic diagram of automatic configuration results in a region configuration page provided by an embodiment of the present application.

FIG. 11 is a schematic diagram of a color attribute configuration page provided by an embodiment of the present application.

FIG. 12 is an exemplary scene diagram showing distributions of a first target object and ghost targets in a target space of an embodiment of the present application.

FIG. 13 is a page schematic diagram of an edge region configuration scene for multiple targets provided by an embodiment of the present application.

FIG. 14 is a flow schematic diagram illustrating a spatial configuration method of an exemplary embodiment.

FIG. 15 is an application process schematic diagram of an environmental model in an embodiment.

FIG. 16 is a first schematic diagram of a spatial configuration page in an embodiment.

FIG. 17 is a second schematic diagram of a spatial configuration page in an embodiment.

FIG. 18 is a third schematic diagram of a spatial configuration page in an embodiment.

FIG. 19 is a fourth schematic diagram of a spatial configuration page in an embodiment.

FIG. 20 is a fifth schematic diagram of a spatial configuration page in an embodiment.

FIG. 21 is a sixth schematic diagram of a spatial configuration page in an embodiment.

FIG. 22 is a seventh schematic diagram of a spatial configuration page in an embodiment.

FIG. 23a is a schematic diagram of a template recommendation page in an embodiment.

FIG. 23b is a schematic diagram of a selection operation involved in an embodiment.

FIG. 24 is a schematic diagram of an editing operation involved in an embodiment.

FIG. 25 is a schematic diagram of an editing operation involved in an embodiment.

FIG. 26 is a structural block diagram of a spatial configuration apparatus of an exemplary embodiment.

FIG. 27 is a structural block diagram of a spatial configuration apparatus of an exemplary embodiment.

FIG. 28 is a hardware structural diagram of an electronic device of an exemplary embodiment.

### DETAILED DESCRIPTION

The embodiments of the present application will now be described in detail. Examples of the embodiments are illustrated in the accompanying drawings, in which the same or similar reference numerals denote the same or similar elements or elements having the same or similar functions throughout. The embodiments described below with reference to the drawings are exemplary, are intended merely to explain the present application, and may not be construed as limiting the present application.

As mentioned above, the related art still lacks a solution for intuitively monitoring each smart device in a scene, which in turn affects the effectiveness of device control services.

Taking a smart home scene as an example, most existing technical solutions only obtain a floor plan formed by the edges of the rooms in a home, and still may not obtain the positions of various smart devices in the smart home scene, so they may not associate the various smart devices with the rooms in which the smart home scene is located, and therefore may not realize intuitive monitoring of the various smart devices in the smart home scene based on the rooms.

At present, monitoring of the various smart devices in a smart home scene mainly relies on a user terminal. For example, in a smart home scene, the user terminal determines, according to device status data reported by an air conditioner in the living room, whether the air conditioner is turned on, the temperature, and the operating mode, and then displays the information. However, under such a monitoring scheme, the user may not intuitively monitor each smart device in the smart home scene, thereby affecting the effectiveness of device control services. In addition, especially for non smart devices in the smart home scene, effective monitoring is difficult; because non smart devices are also important environmental influencing factors, the difficulty of improving the effectiveness of device control services for the whole house is further increased.

From the above, it may be seen that there is still a defect of low effectiveness of device control services in the related art.

To this end, the spatial configuration method provided by the present application may generating a spatial layout diagram of the target space, thereby enabling intuitive monitoring of the corresponding smart devices and improving the effectiveness of device control services. In addition, the spatial configuration method provided by the present application of an embodiment also may generate an environmental model corresponding to a target space to describe the states of second target objects in the target space. Through the environmental model, each second target object in the target space is associated with a spatial layout diagram corresponding to the target space, realizing a spatial position based device monitoring scheme, thereby effectively improving the effectiveness of device control services. Correspondingly, the spatial configuration method is applicable to a spatial configuration apparatus, and the spatial configuration apparatus may be deployed on an electronic device. For example, the electronic device may be a smartphone, a tablet computer, etc.

In order to make the objectives, technical solutions, and advantages of the present application clearer, the implementation manners of the present application will be further described in detail below with reference to the accompanying drawings.

FIG. 1 is a schematic diagram of an implementation environment involved in a spatial configuration method. The implementation environment at least includes a user terminal 110, a smart device 130, a server 170, and network devices. In FIG. 1, the network devices include a gateway 150 and a router 190; this is not intended as a specific limitation.

The user terminal 110, which may also be referred to as a client terminal or simply a terminal, may deploy (also understood as install) a client associated with the smart device 130. The user terminal 110 may be a smartphone, a tablet computer, a notebook computer, a desktop computer, a smart control panel, or other electronic devices having display and control functions; no limitation is imposed herein.

The client, associated with the smart device 130, is essentially an account registered by the user in the client, and the smart device 130 is configured in the client. For example, the configuration includes adding a device identifier for the smart device 130, so that when the client runs on the user terminal 110, the client may provide the user with functions such as device display and device control for the smart device 130. The client may be in the form of an application or a web page. Accordingly, the interface for device display in the client may be in the form of a program window or a web page; this is not limited herein.

The smart device 130 is deployed in the gateway 150 and communicates with the gateway 150 through its own communication module, and is thereby controlled by the gateway 150. It should be understood that the smart device 130 refers to one of a plurality of smart devices 130, and the embodiments of the present application are merely illustrated by way of example with the smart device 130; that is, the embodiments of the present application do not limit the number and types of smart devices deployed in the gateway 150. In one application scene, the smart device 130 accesses the gateway 150 through a local area network and is thus deployed in the gateway 150. The process by which the smart device 130 accesses the gateway 150 through a local area network includes: first establishing a local area network by the gateway 150, and then the smart device 130 joins the local area network established by the gateway 150 by connecting to the gateway 150. The local area network includes, but is not limited to, ZIGBEE or Bluetooth. The smart device 130 may be a smart printer, a smart fax machine, a smart camera, a smart air conditioner, a smart door lock, a smart lamp, or a human body sensor, a door window sensor, a temperature humidity sensor, a water leak sensor, a natural gas alarm, a smoke alarm, a wall switch, a wall socket, a wireless switch, a wall mounted switch, a cube controller, a curtain motor, a millimeter wave radar, etc., configured with a communication module.

It should be noted that the millimeter wave radar may transmit FMCW signals to other smart devices 130, and then receive echo signals reflected from the other smart devices 130, or capture micro-doppler signals generated while the other smart devices 130 are operating, thereby receiving echo signals. Since the echo signals contain all distance segments, moving objects within the detection range of the millimeter wave radar may be detected. Based on this characteristic of the millimeter wave radar, it is possible to effectively monitor other smart devices. The micro-doppler signal refers to vibration waves generated by other smart devices 130 during operation. For example, smart air conditioners, fans, sweeping robots, air purifiers, and rotating computer cases may all generate micro-doppler signals.

Interaction between the user terminal 110 and the smart device 130 may be realized through a local area network or a wide area network. In one application scene, the user terminal 110 establishes a wired or wireless communication connection with the gateway 150 through the router 190. The wired or wireless methods include, but are not limited to, WIFI, etc., so that the user terminal 110 and the gateway 150 are deployed in the same local area network, and the user terminal 110 may thus interact with the smart device 130 through the local area network path. In another application scene, the user terminal 110 establishes a wired or wireless communication connection with the gateway 150 through the server 170. The wired or wireless methods include, but are not limited to, 2G, 3G, 4G, 5G, WIFI, etc., so that the user terminal 110 and the gateway 150 are deployed in the same wide area network, and the user terminal 110 may thus interact with the smart device 130 through the wide area network path.

The server 170, which may also be referred to as a cloud, a cloud platform, a platform end, a server end, etc., may be a single server, a server cluster composed of multiple servers, or a cloud computing center composed of multiple servers, so as to better provide backend services to a large number of user terminals 110. For example, the backend services include device control services.

In one application scene, the user terminal 110 draws a trajectory diagram of each space based on the movement trajectory of the first target object in the target space, and then displays the trajectory diagram of each space corresponding to the target space. Then, by marking the entrance and exit positions of each space on the trajectory diagram, the spatial layout diagram corresponding to the target space is obtained, so that the user terminal 110 may provide the user with more effective device control services based on the spatial layout diagram.

In one application scene, after the user terminal 110 obtains the spatial layout diagram corresponding to the target space, the user terminal 110 may display the spatial layout diagram corresponding to the target space, and then, through echo signals received by the smart device 130, identify the second target objects deployed in the target space and obtain the positions of the second target objects in the target space. Then, based on the positions of the second target objects in the target space and the spatial layout diagram corresponding to the target space, the user terminal 110 generates an environmental model of the target space. Through the environmental model, the states of the second target objects in the target space are described, so that the second target objects in the target space may be monitored more effectively and intuitively, thereby providing the user with more effective device control services.

Of course, in other application scenes, the above spatial configuration process performed by the user terminal 110 may also be implemented by the server 170. At this time, after the server 170 generates the environmental model of the target space, the environmental model of the target space is sent to the user terminal 170 through a wide area network path, and the environmental model is displayed on the user terminal 110, so that the user terminal 110 may provide the user with more effective device control services based on the environmental model.

In one application scene, the user terminal 110 may be configured to: display a region configuration page for the target space, the region configuration page including an edge configuration item; in response to a trigger operation on the edge configuration item, generate prompt information for instructing the first target object to move in the target space; and display, on the region configuration page, an automatically generated edge region, the edge region is determined based on detection information corresponding to the movement of the first target object in the target space.

The smart device 130 or the server 170 serves as a data processing end, or the smart device 130 and the server 170 in combination serve as the data processing end. Among them, the smart device 130 may be a detection device capable of detecting the position of a face, for example specifically a human body sensor, a millimeter wave radar, or the like. In particular, the data processing end is operable to: obtain detection information-collected by the smart device 130 in accordance with a detection instruction-corresponding to movements of the first target object in the target space, the detection instruction is generated in response to a trigger operation on an edge configuration item in the region configuration page; based on the detection information, determine the position of the first target object in the target space and the position of a ghost target corresponding to the first target object; based on the position of the first target object and the position of the ghost target, determine an edge region corresponding to the target space, the obtained edge region is configured to automatically display, in response to the trigger operation on the edge configuration item, in the region configuration page. The region configuration process may include displaying the region configuration page, prompting the first target object to move, collecting detection information during the movement of the first target object, determining the positions of the first target object and the ghost target, determining the edge region, and displaying the edge region on the region configuration page, and the like.

In one application scene, an application (APP) may be installed on the user terminal 110, the application is, for example, a smart home application. When the smart home application runs, it may display a spatial configuration page that includes a spatial region taken from a spatial layout diagram corresponding to the target space, in which previously added second target objects are shown at their respective positions. In a scheme presentation area of the spatial configuration page, a device control scheme generated by matching relationships among the second target objects under the target space is displayed. Based on the second target objects in the spatial region and the respective device control schemes, an intelligent space template is generated; the intelligent space template may then be sent to the server 170, and the server 170 may send the intelligent space template to other terminal devices, so that these other terminal devices may directly use the intelligent space template for spatial configuration, thereby effectively reducing the complexity of spatial configuration and improving configuration efficiency.

In one application scene, the user may view a template recommendation page through the user terminal 110, in which intelligent space templates recommended based on the current geographical position are displayed. The user selects one intelligent space template from the displayed environmental templates. For the user terminal 110, upon detecting selection operation of the user, it responds to the selection operation by displaying a template editing page corresponding to the selected intelligent space template. At this time, the user may edit, within the template editing page, each functional region, device, and device control service in the intelligent space template. The user terminal 110 then, in response to a save operation on the edited intelligent space template, applies the edited intelligent space template to the template space. Consequently, the user is not only recommended an intelligent space template that matches both the current geographical position and the spatial layout of the current space, but may also edit the functional regions, devices, and device control services within the template, effectively reducing the complexity of configuring device control services for smart devices in different rooms of the home, and making the edited intelligent space template more practical and better aligned with user needs, thereby improving smart home experience of the user.

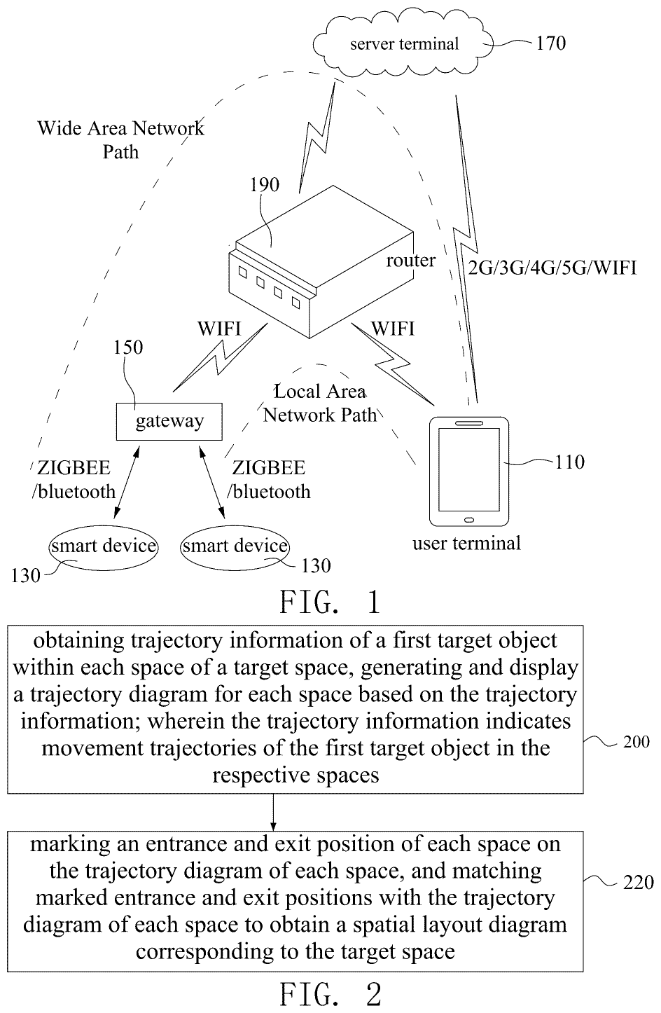

Refer to FIG. 2. An embodiment of the present disclosure relates to a spatial configuration method applicable to an electronic device, which may specifically be the user terminal 110 shown in the implementation environment of FIG. 1.

In the following method embodiments, for ease of description, the electronic device is taken as the executing entity of each step by way of example, but this is not intended as a specific limitation. As shown in FIG. 2, the method may include the following steps:

Step 200: obtaining trajectory information of a first target object within each space of a target space, generating and display a trajectory diagram for each space based on the trajectory information; wherein the trajectory information indicates movement trajectories of the first target object in the respective spaces.

The target space may be an indoor or outdoor scene, for example a space in a home environment, an office scene, a park scene, etc. Each space within the target space is a sub space thereof; for instance, when the target space is a home environment, the spaces may be a bedroom, a living room, a bathroom, etc.

The first target object refers to an object capable of moving within the target space, such as a person or a robot. A trajectory may be the movement path of the first target object within a certain area of the target space, or the motion path of the first target object at a certain position in the target space; no limitation is imposed herein. The trajectory information indicates the movement trajectories of the first target object in the respective spaces.

In one possible implementation, the electronic device uses a radar device to locate the first target object so as to obtain the trajectory information of the first target object.

Specifically, in Step 200, obtaining the trajectory information of the first target object within each space of the target space includes: tracking the trajectory of the first target object based on echo signals to obtain the trajectory information of the first target object in each space. The echo signals are reflections of the radar device's transmitted signals from the first target object.

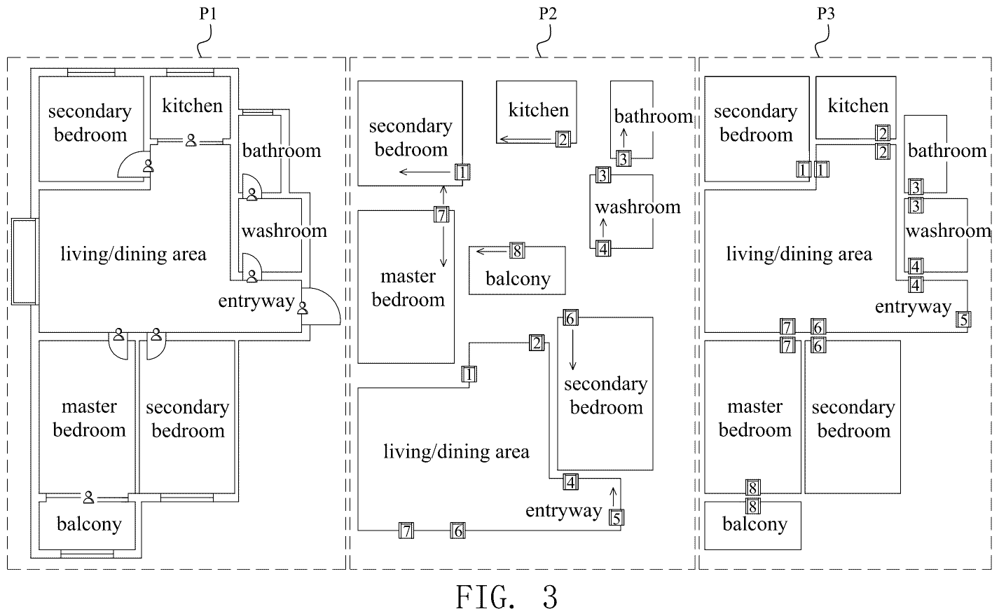

As shown in FIG. 3, an example illustrates the process of generating a corresponding spatial layout diagram from the target space, where P1 is the target space, P2 is a trajectory diagram with entrance and exit positions marked, and P3 is the spatial layout diagram. From P2 it may be seen that the trajectory diagram may be a boundary contour diagram of each space in the target space.

Step 220: marking an entrance and exit position of each space on the trajectory diagram of each space, and matching marked entrance and exit positions with the trajectory diagram of each space to obtain a spatial layout diagram corresponding to the target space.

In one possible implementation, the electronic device determines the entrance and exit positions of each space based on the trajectory information of the first target object in each space. Specifically, Step 220 may include: based on the trajectory information of the first target object in each space, marking the entrance and exit positions of each space on the trajectory diagram of each space; wherein the trajectory information is obtained by tracking a trajectory of the first target object based on echo signals, the echo signals are reflections of a radar device's transmitted signals from the first target object.

The spatial layout diagram describes spatial information such as the relative positions and sizes of the various spaces in the target space. For example, the spaces may be the living room and bedroom in a home environment, a conference room in an office scene, or a recreation area in a park scene. In other words, the spatial layout diagram reflects the boundary positions and orientation relationships of the various spaces in the target space.

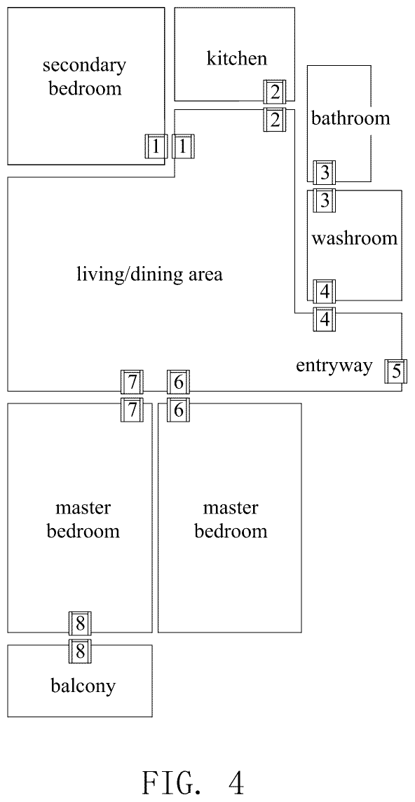

For example, the spatial layout diagram may be a floor plan. In FIG. 4, a spatial layout diagram corresponding to the target space is shown, where the target space is a smart home scene, and the various spaces in this smart home scene at least include a second bedroom, a kitchen, a bathroom, a washroom, a living dining room, two master bedrooms, and a balcony, etc. It may be seen that the spatial layout diagram reflects the boundary positions and orientation relationships of the various spaces in the smart home scene.

In one possible implementation, the electronic device determines the spatial layout diagram of the target space by infrared technology, for example through the following process: the electronic device scans the room with near infrared light to obtain a preliminary floor plan; identifies jumps in the contour of the floor plan, removes the jump contours, and marks the doorway positions and door widths at the jump positions; obtains an in wall floor plan; when a room has multiple doorways, numbers the multiple doorways; measures wall thickness: uses far infrared light to measure the wall thickness at the doorway; room splicing: takes the doorway as a splicing reference, selects the doorways corresponding to two rooms as the splicing basis for splicing, and splices the floor plans of adjacent rooms at a distance equal to the wall thickness to obtain a complete floor plan.

In one possible implementation, the spatial layout diagram of the target space may also be determined by a millimeter wave radar device, for example through the following process: the millimeter wave radar device filters out static points in the point cloud data, retaining dynamic points; performs clustering on the dynamic point data to obtain dynamic point cloud clusters; performs tracking and monitoring on the dynamic point cloud clusters to obtain the movement trajectory of a tester in the area to be measured; processes the movement trajectory to calculate the left boundary, right boundary, and front boundary of the area to be measured. The millimeter wave radar device continuously observes back and forth movement trajectory of the tester to calculate the left, right, and front boundaries of the room that the tester walks each time. Through multiple sets of measurements, the front, left, and right boundaries of the area to be measured are finally determined.

In one possible implementation, the electronic device determines the entrance and exit positions of each space based on the open-close actions of the first target object in each space.

Specifically, Step 220 may include: in response to a spatial open-close event triggered in each space, determining positions of the first target object in each space at a time when the spatial open-close event is triggered; and marking the entrance and exit position of each space at corresponding region on the trajectory diagram of each space based on determined positions.

The spatial open-close event refers to a door open-close event. The first target object may be a person, and the moment when the spatial open-close event is triggered is the moment when the person opens or closes a door.

Accordingly, at the moment a person opens/closes the door of a certain space, the electronic device positions the person by means of the radar device and may thereby take this position as the entrance and exit position of that space.

It may be understood that when the person opens/closes the door, the person's position coincides with the entrance and exit position of each space, so the electronic device may mark the entrance and exit positions of each space on the trajectory diagrams of each space based on the person's position at that moment.

As shown in FIG. 3, because an entrance and exit position connects two adjacent spaces, one entrance and exit position is marked on the trajectory diagrams of two different spaces. In one possible implementation, the user manually marks the access location through the electronic device so as to determine the entrance and exit position.

Specifically, Step 220 may further include: in response to a marking operation on a access location, identifying two adjacent spaces associated with the access location, and marking the access location on trajectory diagrams of the two adjacent spaces as the entrance and exit position of the two adjacent spaces; wherein the access location indicates a position at which the first target object passes when entering or exiting between the two adjacent spaces.

The access location indicates a position at which the first target object passes when entering or exiting between the two adjacent spaces. The marking operation on the access location may be performed manually by the user.

The spatial layout diagram is obtained by matching the trajectory diagrams of the respective spaces whose entrance and exit positions have been marked.

The matching is configured to connect the trajectory diagrams of the respective spaces whose entrance and exit positions have been marked, based on the spatial relationships among the various spaces, the entrance and exit positions, and the like, to obtain the spatial layout diagram.

Please continue to refer to FIG. 3, which illustrates a schematic diagram of generating a spatial layout diagram of the target space in an exemplary embodiment.

The target space P1 is a smart home scene. The first target object (i.e., the user) is caused to move in each space of the target space P1. By tracking with the radar device, the electronic device obtains the trajectory information of the first target object (the user) in each space. For example, in P1 of FIG. 3, this trajectory information includes the movement paths (shown as the user's movement route diagram) of the user in each space of the target space. The electronic device accordingly draws and displays the trajectory diagrams P2 of the respective spaces. By locating the first target object when the spatial open-close event is triggered, the electronic device marks the entrance and exit positions of each space at the corresponding regions on the trajectory diagrams of each space. Finally, based on the entrance and exit positions and the user's movement direction, the electronic device matches the trajectory diagrams of the respective spaces whose entrance and exit positions have been marked to obtain the spatial layout diagram.

Under the effect of the above embodiments, the spatial layout diagram is generated based on the relationship between the movement trajectory of the first target object in the target space and each space in the target space, providing a method of generating a spatial layout diagram by tracking the target object, which is simpler, more convenient, and more efficient than the related art schemes for generating spatial layout diagrams.

For the electronic device, after obtaining the spatial layout diagram corresponding to the target space, it may display the spatial layout diagram on a display screen configured on the electronic device, so as to subsequently generate an environmental model of the target space by combining it with the positions of the second target objects in the target space.

In one embodiment, the method may further include:
displaying the spatial layout diagram corresponding to the target space; and
identifying each second target object deployed in the target space and determining positions of the second target objects in the target space;
generating an environmental model of the target space based on the position of each second target objects in the target space and the spatial layout diagram; wherein the environmental model describes at least one state of the first target object and each second target object in the target space.

The second target object refers to a device or facility deployed in the target space. In one possible implementation, the second target object may be a device capable of generating micro-doppler signals while operating, namely an electronically controlled object. Examples of electronically controlled objects include smart door locks, smart (motorized) curtains, desktop computers, range hoods, electric fans, air conditioners, and the like. The second target object may also be a facility incapable of generating micro-doppler signals, namely a non electronically controlled object, such as a sofa, a wardrobe, a bay window, etc., in the target space, which is not limited herein.

The identification of the second target objects may include identifying the position, the object type, the working state, and the like of the second target object in the target space, which is not limited herein. The object type is configured to distinguish different second target objects; that is, different second target objects have different object types. For example, the object type of air conditioner a is different from that of plant c, whereas air conditioner a and air conditioner b have the same object type. The working state describes the operational condition of the second target object, for example, the working state includes an ON state, an OFF state, a fault state, and so on.

When the second target object is an electronically controlled object, in one possible implementation, the position of the electronically controlled object in the target space is identified by the radar device. In one possible implementation, the working state of the electronically controlled object is identified by the radar device.

When the second target object is a non electronically controlled object, in one possible implementation, the position of the non electronically controlled object in the target space is indirectly identified by the radar device through identifying the position of the first target object that interacts with the non electronically controlled object.

When the second target object is a smart device, in one possible implementation, the electronic device identifies the device type of the smart device by combining device status data reported by the smart device and micro-doppler signals captured by the radar device while the second target object is operating.

In one possible implementation, the user identifies the object type of a second target object by operating the electronic device (manual marking), image recognition, or other means.

In one embodiment, the method may further include: generating an environmental model of the target space based on the positions of the second target objects in the target space and the spatial layout diagram corresponding to the target space.

The environmental model describes at least one state among the states of the first target object and the second target objects in the target space. The state may refer to the object type of at least one among the first target objects and the second target objects in the target space, may also refer to the working state of at least one among the first target objects and the second target objects in the target space, and may also refer to the position, trajectory, movement state, etc., of at least one among the first target objects and the second target objects in the target space, which is not specifically limited herein.

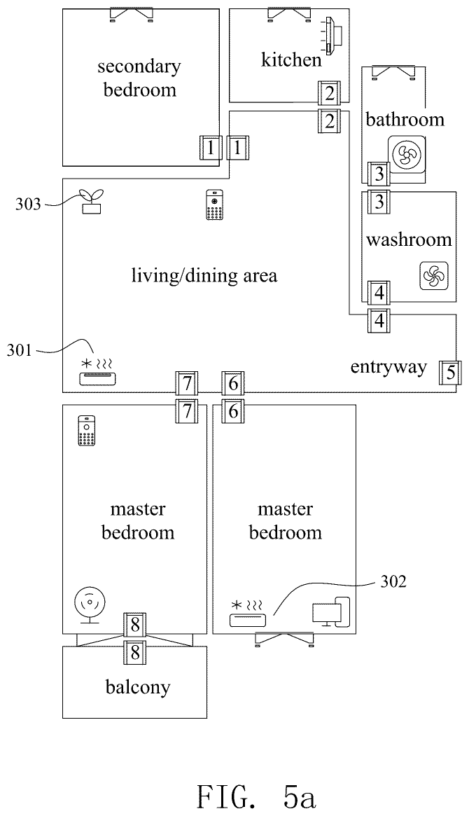

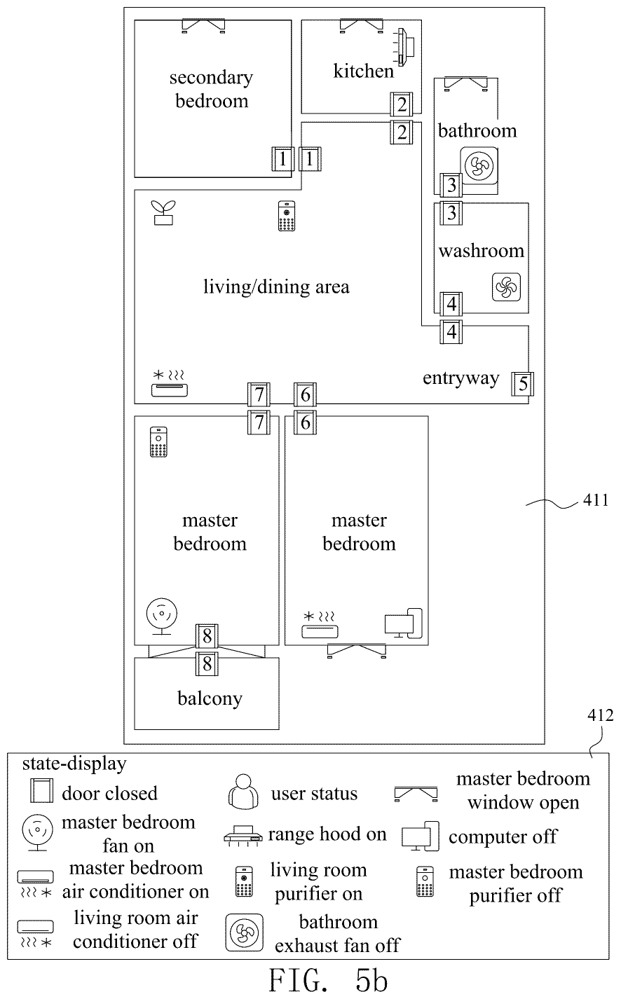

In one possible implementation, FIG. 5a shows a schematic diagram of the environmental model of a smart home scene. From FIG. 5a it may be seen that the environmental model of the smart home scene may reflect the positions, object types, and working states of the second target objects in the smart home scene. For example, second target object 301 and second target object 302 have the same object type, both indicating that the second target object is an air conditioner: air conditioner 301 is located at the lower left corner of the living dining room and is in the OFF state; air conditioner 302 is located at the lower left corner of the master bedroom and is in the ON state; the object type of second target object 303 indicates that the second target object is a plant, plant 303 is located at the upper left corner of the living dining room and has no working state.

In one possible implementation, FIG. 5b shows a schematic diagram of the environmental model of a smart home scene, in which the illustrated portion 411 of the environmental model includes the positions, object types, and working states of the second target objects in the smart home scene, and may also include at least one of the trajectories and movement states of the first target objects in the smart home scene. FIG. 5b also includes a state display area 412 for at least one of the first target objects and the second target objects, in which the states of the first target objects in the smart home scene and the states of the second target objects in the smart home scene may be displayed separately.

For example, in the state display area 412 the electronic device may display the state of the user acting as the first target object; specifically, it may include the user's trajectory in the smart home scene and the movement state, such as still, sitting, fallen, etc., which may be obtained by detecting the human body state in the smart home scene. In the state display area 412 the electronic device may also display the states of various detectable devices and/or facilities acting as second target objects in each regional space. For example, it may be detected that all doors are in the closed state, the master bedroom window is in the open state, the master bedroom fan is in the ON state, the range hood is in the ON state, the computer is in the OFF state, the master bedroom air conditioner is in the ON state, the living room purifier is in the ON state, the master bedroom purifier is in the OFF state, the living room air conditioner is in the OFF state, the bathroom exhaust fan is in the OFF state, and so on. Thus, by displaying the states of the target objects in each region of the target space with icons and text in a separate area, the electronic device allows the states of the first target objects and the second target objects in the target space to be grasped more intuitively.

In one possible implementation, the environmental model is realized by displaying object markers of the second target objects in the spatial layout diagram. Specifically, generating the environmental model of the target space based on the positions of the second target objects in the target space and the spatial layout diagram may include the following steps:
determining a corresponding region in the spatial layout diagram for each second target object, based on the position of the second target object in the target space; displaying an object marker for each second target object in the corresponding region of the spatial layout diagram, to generate the environmental model of the target space. After displaying the object marker for each second target object in the corresponding region of the spatial layout diagram, to generate the environmental model, the method further includes: based on an association relationship between each already displayed second target object and signal features of echo signals, identifying a newly deployed second target object in the target space; the echo signals are obtained by a radar device capturing micro-doppler signals generated while the second target object is operating;
displaying an object marker of the newly deployed second target object in the corresponding region of the spatial layout diagram, so as to update the environmental model.

Determining a corresponding region in the spatial layout diagram for each second target object, that is, the electronic device matches the position of the second target object in the target space into the coordinate system of the spatial layout diagram, so as to map the position of the second target object in the target space onto the corresponding region in the spatial layout diagram.

The object marker of a second target object indicates the state of the second target object.

In one possible implementation, the object marker of a second target object may be an icon of different shapes and colors, the shape and color of the object marker indicating the object type and working state of the second target object. Taking FIG. 5a as an example: object marker 301 has an air conditioner shape and a light gray color, indicating that the object type of the second target object is air conditioner and that the air conditioner is in the OFF state, i.e., “air conditioner OFF”; object marker 302 has an air conditioner shape and a dark black color, indicating that the object type of the second target object is air conditioner and that the air conditioner is in the ON state, i.e., “air conditioner ON”; object marker 303 has a plant shape, indicating that the object type of the second target object is plant. It should be noted that some second target objects have no working state attribute. Moreover, the position of the object marker in the environmental model may map the position of the corresponding second target object in the target space, so that the environmental model may also reflect the position of the second target object in the target space.

Through the above process, a spatial position based device monitoring scheme is provided: the electronic device uses the environmental model to associate each second target object in the target space with the spatial layout diagram corresponding to the target space, so that the second target objects (i.e., various devices and facilities) in the target space may be monitored intuitively, dynamically, and in real time through the environmental model, and their real time working states may be grasped promptly, thereby helping to improve the effectiveness of device control services.

It may be understood that the object types of the second target objects in the target space differ, so the echo signals formed by the micro-doppler signals generated while the second target objects are operating also differ. Based on this, the electronic device may identify second target objects of the same object type based on the already displayed second target objects. Specifically, for each of displayed second target objects in the environmental model, the signal features of the formed echo signals have been associated with the corresponding second target object, so the electronic device may identify a newly deployed second target object in the target space based on this association relationship.

For example, the object types of the range hood and the exhaust fan are different, and the echo signals formed by the micro-doppler signals generated during their operation are also different, so the electronic device associates them with the signal features of the corresponding echo signals. When a new exhaust fan is deployed in the target space, the object type of the newly deployed exhaust fan may be identified based on this association relationship through the echo signals of the newly deployed exhaust fan.

In one possible implementation, the electronic device obtains the position of the newly deployed second target object in the target space based on the echo signals generated by the newly deployed second target object, so as to determine the corresponding region of the newly deployed second target object in the spatial layout diagram, and further updates the environmental model of the target space, that is, marks the newly deployed second target object in the corresponding region of the spatial layout diagram.

Of course, in addition to updating the environmental model of the target space by identifying newly deployed second target objects, the electronic device may also update the environmental model by identifying changes in the working state each of displayed second target objects in the environmental model. For example, every time the exhaust fan is turned on, the millimeter wave radar receives the same echo signal, which disappears after the exhaust fan is turned off. The electronic device establishes an association relationship between this echo signal and the working state of the exhaust fan, and may identify whether the exhaust fan is currently in the ON or OFF state based on the presence or absence of a similar echo signal, thereby updating the environmental model and ensuring that the environmental model dynamically reflects the real time working states of the second target objects in the target space.

Through the above process, the electronic device learns the signal features of the echo signals reflected/scattered by the already displayed second target objects, establishes an association relationship between specific signal features of the echo signals and the object type and working state of the second target object, and thereby identifies at least one of the object type and working state of the newly deployed second target object through the signal features of the echo signals reflected/scattered by the newly deployed second target object, and further updates the environmental model. This fully ensures that the environmental model may dynamically reflect changes and real time working states of the second target objects in the target space, further enhancing the real time monitoring capability of the various devices and facilities in the target space, and thus helping to further improve the effectiveness of device control services.

As mentioned above, the second target object refers to a device or facility deployed in the target space; specifically, the second target objects include electronically controlled objects and non electronically controlled objects.

An electronically controlled object is a device capable of generating micro-doppler signals while operating. A non electronically controlled object is a facility incapable of generating the micro-doppler signals. The micro-doppler signals refer to vibration waves actively or passively generated by the second target object during operation, such as plants swaying in the wind, curtains are pulled, air conditioners, fans, sweeping robots, pots vibrating due to heating, air purifiers, and computer cases with rotating fans, all of which may generate the micro-doppler signals.

The identification of each second target object deployed in the target space will now be described in detail:

In an exemplary embodiment, when the second target object is an electronically controlled object, identifying each second target object deployed in the target space may include the following steps:
locating a position of the electronically controlled object based on echo signals, and identifying a position of the electronically controlled object in the target space, to determine a corresponding region for the electronically controlled object in the spatial layout diagram.

The echo signals are obtained by the radar device capturing micro-doppler signals generated while the electronically controlled object is operating.

In this manner, the electronic device uses the radar to locate the position of the electronically controlled object in the target space, establishing an accurate matching relationship between the electronically controlled object and the spatial layout diagram, thereby making the environmental model more accurate and enhancing environmental supervision capability.

When the second target object is an electronically controlled object, identifying each second target object deployed in the target space may further include the following steps: based on the radar device's capture of the micro-doppler signals generated while the electronically controlled object is operating, identifying a state of the electronically controlled object as an ON state, so as to mark the electronically controlled object that is in the ON state within the corresponding region determined in the spatial layout diagram.

That is, when the electronically controlled object begins to operate, a certain specific micro-doppler signal always appears in the corresponding region. Then, based on the radar device's capture of the micro-doppler signals generated while the electronically controlled object is operating, the electronic device may identify the working state of the electronically controlled object as the ON state.

In this manner, the identification of the working state of the electronically controlled object is realized, providing a basis for generating the environmental model, facilitating real time and dynamic grasp of the working states of the second target objects in the target space, thereby effectively monitoring the second target objects and enhancing the monitoring capability for devices and facilities.

When the second target object is a non electronically controlled object, identifying each second target object deployed in the target space may further include the following steps:
locating a position of the first target object interacting with the non electronically controlled object based on echo signals, to obtain the position of the first target object within the target space;
identifying a position of the non electronically controlled object in the target space based on the position of the first target object in the target space, so as to determine a corresponding region of the non electronically controlled object in the spatial layout diagram.

The echo signals are obtained by reflection of the radar device's transmitted signal off the first target object.

The first target object refers to an object capable of moving in the target space, such as a person or a robot. A non electronically controlled object refers to a facility incapable of generating micro-doppler signals, such as a sofa in the target space.

For example, as a person interacts with a sofa, such as sitting on it, the electronic device locates the person based on echo signals to obtain the person's position in the target space, and further calculates the edge position of the sofa area based on the person's position in the target space and the approximate height of the person, thereby identifying the position of the sofa in the target space.

In the above process, the inventors realized that non electronically controlled objects may not generate micro-doppler signals, and the radar device has poor ability to identify and locate stationary objects, that is, it is difficult to directly locate non electronically controlled objects. Therefore, for non electronically controlled objects, the electronic device locates the first target object interacting with the non electronically controlled object to obtain the position of the first target object, and indirectly identifies the position of the non electronically controlled object in the target space, overcoming the defect of difficulty in effectively monitoring non electronically controlled objects, and ensuring that non electronically controlled objects, as important environmental influencing factors, may also effectively provide device control services for the user.

In another case, the second target object is an unknown smart device. Correspondingly, in an exemplary embodiment, identifying each second target object deployed in the target space may further include the following steps: when detecting that the working state of the smart device has changed from the OFF state to the ON state, determining a region range of the smart device within the target space; within the determined operational region, in response to the radar device capturing micro-Doppler signals generated by the smart device during operation, identifying the device type of the smart device as the object type of the second target object, so as to mark the second target object based on the device type of the smart device within the spatial layout diagram.

It should be noted that the smart device capable of detecting working state changes here is a known smart device in the target space, that is, the smart device has already been deployed in the gateway 150 shown in the implementation environment of FIG. 1, and the smart device may report device status data via the gateway 150, so that the server 170/user terminal 110 may detect whether the working state of the smart device has changed.

For example, the working state of the smart air conditioner in the bedroom changes from the OFF state to the ON state, and the smart air conditioner reports its own device status data via the network device, the device status data indicating the working state of the smart air conditioner. After the server or the user terminal detects the change in the working state, it first determines the region range of the smart air conditioner in the smart home scene, so as to subsequently determine whether an unknown smart device, that is, a second target object that generates micro-doppler signals while operating, exists within that region range in the bedroom, and further determine the object type of the second target object.

Continuing with the above example, within the determined region range of the bedroom, the radar device ascertains, from the received echo signals, that micro-doppler signals generated while the second target object is operating have been captured. Based on the step “when detecting that the working state of the smart device has changed from the OFF state to the ON state, determining a region range of the smart device within the target space,” the corresponding change in the working state of the smart device is detected. Thereby, the smart device whose working state has changed is associated with the second target object detected by the radar device—that is, it is determined that the second target object is the bedroom's smart air conditioner-thus completing the identification of the object type of the second target object.

In the above process, by virtue of the Internet of Things attribute of the smart device, device status data of every smart device deployed in the gateway may be acquired by the electronic device. Unknown smart devices are thereby linked with known smart devices, so that the electronic device may determine the object type of the second target object—i.e., the device type of the corresponding smart device—further facilitating effective monitoring of each smart device in the target space and thus improving the effectiveness of device control services.

For the second target objects in the target space, in addition to automatic recognition by the electronic device, recognition may also be performed in other ways. In an exemplary embodiment, identifying each second target object deployed in the target space may further include: in response to a type marking operation on a second target object, identifying the object type of the second target object; or in response to a recognition event triggered by an image capture device for the second target object, identifying the object type of the second target object.

In one possible implementation, the type marking operation for a second target object may be a manual marking operation by the user, thereby completing identification of the object type of the second target object through the user's manual marking. The user's manual marking operation may be actively triggered by the user or passively triggered—for example, the electronic device generates a marking prompt for prompting the user to perform manual type marking for the second target object-without limitation herein.

The image capture device may be a camera, a smartphone equipped with a camera, etc. The recognition event triggered by the image capture device for the second target object may refer to the image capture device capturing an image to be recognized that contains the second target object and performing image recognition on that image, thereby identifying the object type of the second target object.

By identifying the object type of a second target object through either the type marking operation or the recognition event triggered by the image capture device, the electronic device provides additional recognition methods, strengthening the environmental model's supervisory capability over the devices and facilities (i.e., the second target objects) in the target space.

With the cooperation of the above embodiments, full consideration is given to the possibility that different second target objects may exist in the target space in various forms. Different recognition methods are provided for different second target objects, satisfying the recognition requirements for each kind of second target object, so that more devices and facilities in the target space may be recognized and each second target object may be recognized more accurately. By acquiring the positions, working states, and object types of the second target objects, the electronic device generates the environmental model, allowing the user to intuitively understand the positions, object types, or working states of the second target objects in the target space and to supervise the devices and facilities in the target space dynamically and in real time.

In one embodiment, the method may include the following steps:
displaying an environmental model corresponding to the target space; when a change in at least one state among the first target objects and the second target objects is recognized, displaying at least one of an updated first target object and an updated second target object in the environmental model. The environmental model includes at least one state among the first target objects and the second target objects in the target space. The environmental model is generated based on the spatial layout diagram of the target space and positions of the second target objects in the target space. The spatial layout diagram is generated based on a relationship between the trajectory of the first target object in the target space and each space in the target space.

First, it is noted that the environmental model includes at least one state among the first target objects and the second target objects in the target space. The state may be the object type of at least one among the first target objects and the second target objects, may be the working state of at least one among them, or may be at least one of the position, trajectory, and movement state of at least one among them, without limitation.

Regarding generation of the environmental model of the target space, the electronic device generates it based on the spatial layout diagram of the target space and the positions of the second target objects in the target space. The spatial layout diagram is generated based on the relationship between the trajectory of the first target object in the target space and each space in the target space.

Next, the first target object is an object capable of moving in the target space, such as a person or a robot, so that the electronic device may generate the spatial layout diagram based on the relationship between the trajectory of the first target object in the target space and each space in the target space, and then use it as a basis for generating the environmental model of the target space. The trajectory may be the movement trajectory of the first target object in a certain area of the target space or the motion trajectory at a certain position, without limitation.

The second target object refers to a device or facility deployed in the target space. In one possible implementation, the second target object may be a device capable of generating micro-doppler signals while operating—that is, an electronically controlled object—examples of which include smart door locks, smart (motorized) curtains, desktop computers, range hoods, electric fans, air conditioners, etc. The second target object may also be a facility incapable of generating micro-doppler signals—that is, a non electronically controlled object-such as sofas, wardrobes, bay windows in the target space, without limitation.

The states of the first target objects and/or the second target objects may be represented by different object markers, which may be icons of different shapes and colors. The electronic device uses icons of different shapes and colors to indicate the states—including but not limited to object type, working state, and position—of the first target objects and/or the second target objects.

Refer again to FIG. 5a: object marker 301 has an air conditioner shape and a light grey color, indicating that the object type of the second target object is air conditioner and that the air conditioner is in the OFF state (“air conditioner OFF”); object marker 302 has an air conditioner shape and a dark black color, indicating that the object type of the second target object is air conditioner and that the air conditioner is in the ON state (“air conditioner ON”); object marker 303 has a plant shape, indicating that the object type of the second target object is plant. It should be noted that some second target objects have no working state attribute. Moreover, the position of an object marker in the environmental model may map the position of the corresponding second target object in the target space, so the environmental model essentially also reflects the position of the second target object in the target space.

Refer again to FIG. 5b, which shows a schematic diagram of the environmental model of the smart home scene. Illustrated portion 411 includes the positions, object types, and working states of the second target objects in the smart home scene, and may also include at least one of the trajectories and movement states of the first target objects. FIG. 5b also includes a state display area 412 for the first target objects and/or the second target objects, in which the states of the first target objects and the states of the second target objects may be displayed separately. By displaying, in a separate area, the states of the target objects in each region of the target space with icons and text, the user may grasp the states of the first and second target objects more intuitively.

Through the above embodiments, the electronic device displays the environmental model on its interface and, based on changes in the states of the first target objects and/or the second target objects, promptly updates the displayed environmental model, enabling the user to intuitively and in real time grasp at least one state among the first and second target objects in the target space.

Compared with the related art, the embodiments of the present application provide the following advantageous effects:
1. The environmental model describes the object type and/or state of the second target objects in the target space, enabling spatial position based supervision of devices and facilities, so that the user may remotely and intuitively grasp the real time states of the devices and facilities in the target space, facilitating further management of these devices and facilities.
2. The electronic device generates the spatial layout diagram of the target space based on the relationship between the trajectory of the first target object in the target space and each space in the target space, identifies each second target object deployed in the target space to obtain the position of the second target object in the target space, and then generates the environmental model of the target space based on the spatial layout diagram and the positions of the second target objects. The environmental model describes the object type and/or state of the second target objects. Thus, the electronic device may associate the second target objects with the spatial layout diagram, providing a spatial position based environmental supervision method that allows intuitive, dynamic, and real time supervision of the various devices and facilities in the target space through the environmental model, real time acquisition of the states of the second target objects (i.e., the devices and facilities) in the target space, and improved real time monitoring and management capability for the devices and facilities in the target space. The present solution helps the user intuitively supervise the devices and facilities in the target space and understand the real time states of different devices, facilitating management of the devices in the target space.
3. The electronic device learns the signal features of the echo signals reflected/scattered by the already displayed second target objects, establishes an association relationship between the signal features of specific echo signals and the object type and state of the second target object, and thereby identifies the object type and/or state of a newly deployed second target object through the signal features of the echo signals reflected/scattered by the newly deployed second target object, and updates the environmental model accordingly. Of course, for displayed second target objects in the environmental model, the electronic device may identify their states through the signal features of their echo signals and update the environmental model. Updating the environmental model ensures that it dynamically reflects the real time states of the second target objects in the target space and, after a new second target object is deployed, promptly presents the newly deployed second target object in the environmental model, further enhancing the real time supervision capability for the target space.
4. Considering that non electronically controlled objects may not generate micro doppler signals and that radar has poor ability to identify and locate stationary objects—that is, it is difficult to directly locate non electronically controlled objects—the electronic device may locate the first target object interacting with a non electronically controlled object to obtain the position of the first target object, and indirectly identify the position of the non electronically controlled object in the target space, overcoming the defect of difficulty in locating non electronically controlled objects.
5. Owing to the Internet of Things attribute of smart devices, data information of the smart devices may be acquired. When the electronic device detects that the state of a smart device has changed from the OFF state to the ON state, it captures, within the corresponding region range via radar, the micro-doppler signals generated while the second target object is operating—that is, it discovers the second target object, and associates the discovered second target object with the smart device, thereby determining the object type of the second target object, which is the device type of the corresponding smart device. The above embodiment provides an identification method for smart devices, satisfying the recognition requirements for different second target objects.
6. Fully taking into account that second target objects of different forms may exist in the target space, different identification methods are provided for different second target objects so as to satisfy the identification requirements for each kind of second target object. Consequently, more devices and facilities in the target space may be identified and each second target object may be identified more accurately. The electronic device may obtain the position, state and object type of every second target object to generate the environmental model, so that the user may intuitively learn the position, object type or state of every second target object in the target space and may supervise the devices and facilities in the target space dynamically and in real time.
7. The spatial layout diagram is generated based on the relationship between the trajectory of the first target object in the target space and each space in the target space, providing a method of generating the spatial layout diagram by tracking the target object, which is simpler, more convenient and more efficient than the related art schemes for generating spatial layout diagrams.

In one embodiment, the trajectory diagram may be a boundary contour diagram of each space in the target space. The trajectory diagram includes an edge region. As shown in FIG. 3, P2 is a trajectory diagram that has marked entrance and exit positions and an edge region, and P3 is the spatial layout diagram. From P2 it may be seen that the trajectory diagram may be a boundary contour diagram of each space in the target space.

The edge region is determined based on detection information corresponding to movements of the first target object in the target space. The edge region may be the region corresponding to the boundary of the area in which the first target object moves in the target space, or the region corresponding to the boundary that limits the movement of the first target object in the target space. For example, it may specifically be a wall region or an obstacle region in the target space. The trajectory information is obtained from detection information collected while the first target object moves in each space of the target space.

Please refer to FIGS. 2 and 5b simultaneously. The step of obtaining the trajectory information of the first target object within each space of the target space, generating and displaying the trajectory diagram for each space based on the trajectory information includes:
displaying a region configuration page for the target space; in response to a trigger operation on the edge configuration item, generating prompt information, wherein the prompt information indicates the first target object move within each space of the target space; obtaining trajectory information of the first target object within each space of the target space, wherein the trajectory information is derived from detection information obtained while the first target object moves within the spaces; displaying the edge region on the region configuration page, wherein the edge region is determined from the detection information corresponding to movements of the first target object in the target space; generating and displaying the trajectory diagram for each space based on the trajectory information and the edge region.

In the embodiments of the present application, in order to deploy an intelligent automatic control scheme in a space, it is first necessary to determine the spatial region range in which the automatic control scheme is to be deployed. Taking a smart home as an example, before deploying an automatic control scheme for household appliances, the indoor space in which the scheme is to be implemented may first be determined—i.e., the edge region of the indoor space may first be determined, specifically the walls of the indoor space. The indoor walls serve as boundaries for determining the indoor space where the household appliance automatic control scheme is to be deployed, so that when a target is subsequently detected as appearing in that indoor space, the household appliance automatic control may be executed to realize automatic control of household appliances in the smart home.

The above is only an example; the embodiments of the present application may also be applied to the configuration process of edge regions in other scenes, such as home scenes, office places, indoor sports venues, indoor parking lots, etc. The listed examples are not intended to limit implementation of the present solution.

It should be noted that the spatial region described in the present application may be understood as the region configured for the target space in the region configuration page. When the user terminal configures the spatial region for deploying an automatic control scheme, in order to improve the accuracy of the configured edge region, the user may be allowed to participate in the configuration process of the edge region so that after the edge region has been configured, the user may confirm its accuracy or perform other edits to satisfy personal requirements and enhance the user's participation experience.

In the embodiments of the present application, to enable the user to participate in the configuration process of the edge region, a region-configuration page on the user terminal interface may provide the user with a participation path. Specifically, a relevant application for region configuration may be pre-installed on the user terminal, or a web page may be configured to display the corresponding region configuration page on the user terminal interface, so that the user may select configuration functions or set relevant configuration parameters in the region configuration page to configure the edge region.

The region configuration page may be a content screen containing relevant information on region configuration, for example, including one or more configuration function controls and a display area for the configured edge region. As an example, the region configuration page may include a function bar and a content display area. The content display area is not limited to displaying the configured spatial region and the edge region corresponding to that spatial region. The function bar may include multiple function controls, such as an automatic configuration item, an edge configuration item, a color configuration item, a save item, a region adjustment item, etc. It should be noted that the above function controls may be on the same page or on different pages after jumping.

The region configuration page at least includes an edge configuration item, which is configured to trigger the edge region configuration function to execute relevant logic for edge region configuration and achieve the configuration process of the edge region.

Specifically, when the target application for region configuration is installed on the user terminal, the user may enter the region configuration page through the target application, or connect to the region configuration page through a web page. At this time, the region configuration page is displayed on the display interface of the user terminal, and the page at least contains an edge configuration item. Afterwards, the user may trigger the edge configuration item to start the edge configuration flow for the spatial region.

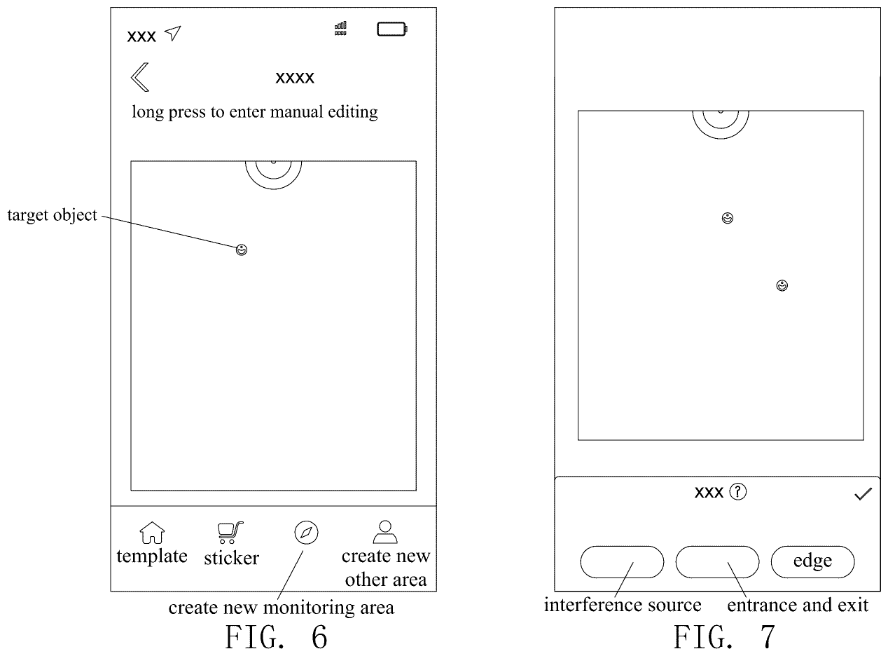

As an example, referring to FIG. 6, the user terminal has installed a target application related to region configuration. When the user opens the target application, an initial page is displayed on the user terminal interface. The initial page is not limited to including a function bar and a content display area. The function bar includes “template”, “sticker”, “new monitoring region”, “new other region”, etc. Above the function bar is the content display area, namely the “Edit Region”. The user performs manual editing by triggering the “Edit Region”. When the user triggers the “new other region” item in the function bar, the initial page jumps to the region configuration page.

Referring to FIG. 7, the function bar of the region configuration page may include multiple attribute items such as “Interference Source”, “Entrance and exit” and “edge”. The “edge” control is the edge configuration item. The user may trigger the edge configuration item to configure the spatial region. The above is only an example and is not intended as a specific limitation on implementing the present application.

Through the above methods, the user terminal may display the region configuration page so that the user may subsequently participate in the configuration of the spatial region through the region configuration page, thereby achieving personalization of the configured region and improving the accuracy when configuring the edge of the spatial region.

The edge configuration item may serve as a control for triggering automatic configuration of the edge region.

In the embodiments of the present application, when the user triggers the edge configuration item in the region configuration page through the user terminal, the automatic configuration region mode may be entered. In this automatic configuration region mode, relevant information on the first target object's movement needs to be combined to determine the edge of the spatial region. Therefore, the user terminal generates prompt information for instructing the first target object to move in the current target space. At this time, a relevant detection device collects information on the first target object's movement in the target space so that the spatial region corresponding to the target space may later be constructed in the region configuration page based on the detection information.

As an example, after the user triggers the edge configuration item in the region configuration page of FIG. 7 through the user terminal, the edge attribute configuration page may be displayed directly or jumped to, or the automatic configuration region mode may be entered to further trigger the automatic configuration region mode.

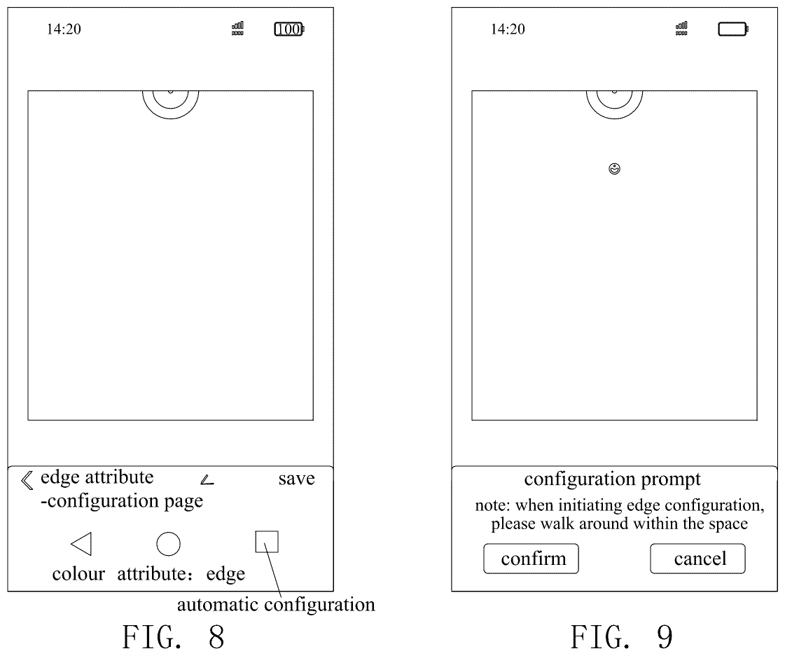

Specifically, after the user terminal triggers the edge configuration item, the function bar area may directly display or jump to the edge attribute configuration page. As shown in FIG. 8, the edge attribute configuration page includes an “automatic configuration” item. After the “automatic configuration” item is triggered, the automatic configuration region mode may be entered. In this mode, the user terminal generates prompt information to instruct the first target object to move in the target space, so that after the detection information on the movement of the first target object has been collected, the edge region is displayed in the region configuration page. The obtained configuration result is shown in FIG. 8, including the edge region and the spatial region enclosed by the edge region. The prompt information includes at least one of voice prompt, vibration prompt, text prompt and image prompt.

In some embodiments, after the user terminal generates the prompt information, the first target object's movement is indicated by the prompt information. If the prompt method is a voice prompt, the prompt information may be a voice prompt for prompting the first target object to move. The voice prompt corresponding to the prompt information is played so that the first target object may move in the target space based on the voice prompt until information collection ends.

In some embodiments, after the user terminal generates the prompt information, other functions of the user terminal may also be configured to prompt the first target object to move in the target space. For example, if a tactile prompt is realized by means of vibration of the user terminal, the prompt information may be a vibration signal for prompting the first target object to move. During the movement of the first target object, the user terminal remains in a vibrating state until information collection is completed, after which the vibration prompt stops.

In some embodiments, after the user terminal generates the prompt information, the prompt information may also be displayed in text and/or image form to instruct the first target object to move in the target space. For example, after the prompt information is generated, the text corresponding to the prompt information may be displayed in the region configuration page.

As an example, referring to FIGS. 7-9, after the user triggers the edge configuration item in the region configuration page of FIG. 7 via the user terminal, the edge attribute configuration page may also be entered. As shown in FIG. 8, when the user selects the “automatic configuration” item in the attribute configuration page, prompt information is displayed at the bottom of the region configuration page, namely the “configuration prompt” shown in FIG. 9. After reading the text related to the “configuration prompt”, the user may trigger the “confirm” or “cancel” item through the user terminal to decide whether to proceed with the region configuration process. When the user triggers “confirm”, the user may move based on the prompt information in the region configuration page so that the detection device may collect relevant information on the moving first target object until the region configuration page of the user terminal switches to display another prompt informing that information collection is complete, for example, “information collection complete; no need to continue moving”.

In some embodiments, after the user terminal generates the prompt information, the first target object may also be prompted to move by displaying an icon or by distinctively displaying part of the page in the region configuration page.

Specifically, since the user terminal interface is generally quadrilateral, in order to enable the user to better cooperate with information collection, the user terminal may generate a prompt signal on any side around the region configuration page to indicate the direction in which the first target object should move in the target space.

For example, because the display interface of the user terminal is usually rectangular, the region configuration page is also generally rectangular, each side of the rectangle representing a direction. The top of the region configuration page represents the forward direction, the bottom represents the backward direction, the left side represents the leftward direction, and the right side represents the rightward direction. After the user terminal generates the prompt information, the prompt information may include an indication icon to be displayed and the display position of the indication icon. Based on the prompt information, the indication icon is displayed at the corresponding position in the region configuration page to instruct the first target object to move in the direction indicated by the position of the indication icon in the region configuration page.

As an example, taking the indication icon, it may be an “arrow” with direction indicating attributes. When the user needs to be prompted to move leftward in the target space, the user terminal displays a left pointing “arrow” on the left side of the region configuration page. When the user needs to be prompted to move forward, the user terminal displays an upward pointing arrow at the top of the region configuration page. When the user needs to be prompted to move backward, the user terminal displays a downward pointing arrow at the bottom of the region configuration page, and so on.

As an example, taking the method of distinctively displaying part of the page, the distinctive display may be a colored icon different from the rest of the page. Specifically, the icon may be a strip shaped icon. When the user needs to be prompted to move rightward in the target space, the user terminal displays the colored strip shaped icon on the right edge of the region configuration page. When the user needs to be prompted to move forward, the user terminal displays the colored strip shaped icon on the top edge of the region configuration page, and so on. During display, the color may be any color, such as red, green, blue, etc., and the display method may be flashing.

It should be noted that the user terminal may combine multiple prompt methods of the prompt information to determine how to prompt the first target object to move. For example, after prompting the first target object to move in the target space by text, the direction of movement in the target space is indicated by an icon until information collection of the first target object's movement is completed.

Through the above methods, after the user triggers the edge configuration item in the region configuration page, prompt information may be generated to instruct the first target object to move in the target space so that a relevant detection device may collect information on the first target object's movement in the target space and calculate the edge region of the spatial region to be configured.

In the embodiments of the present application, after the user terminal collects the movement process of the first target object, detection information on the movement process of the first target object in the target space may be obtained, and then the edge region corresponding to the spatial region of the first target object may be determined.

The edge region is determined based on the detection information corresponding to the movements of the first target object in the target space, and is further automatically generated and displayed at the corresponding edge position of the spatial region in the region configuration page.

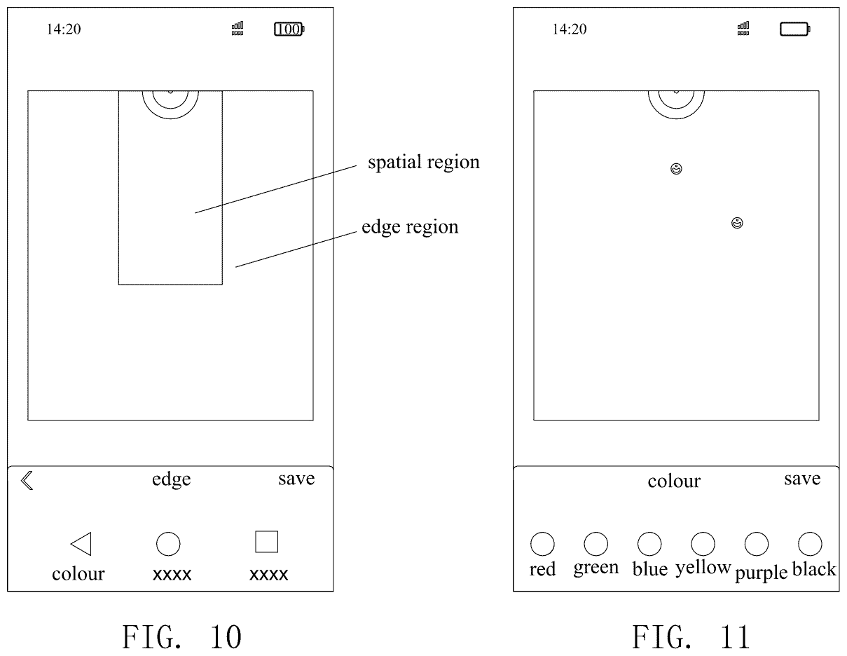

It should be noted that after the user terminal obtains the detection information on the movement of the first target object in the target space, the user terminal may directly calculate and determine the edge position of the spatial region corresponding to the target space in the region configuration page based on the detection information, thereby determining the edge region at the edge position. In addition, the detection information on the movement process of the first target object in the target space may be collected by a dedicated detection device, and the detection device or another processing end may calculate the edge region of the spatial region in the region configuration page based on the detection information. Then the user terminal may automatically generate the edge region at the edge position of the spatial region in the region configuration page, thereby completing region configuration. The configuration result may be seen in FIG. 10.

In some embodiments, the process of displaying the automatically generated edge region in the region configuration page may be: the user terminal obtains detection information on the movement of the first target object in the target space; the detection information includes position information of the first target object and may also include position information of a ghost target mapped by the first target object. Then the user terminal generates the edge region corresponding to the target space based on the detection information and displays the automatically generated edge region in the region configuration page of the user terminal.

In some embodiments, after the user terminal displays the automatically generated edge region in the region configuration page, to ensure the accuracy of the configured spatial region or to satisfy the user's personalized requirements for the spatial region, the user terminal may provide the user with an active adjustment path for the region.

For example, after the step of displaying the automatically generated edge region in the region configuration page, the method may further include:
in response to an adjustment operation on the edge region, displaying a target edge region adjusted on the region configuration page;
in response to a trigger operation on a save item in the region configuration page, synchronizing the target edge region to a detection device providing the detection information.

Specifically, after the edge region in the region configuration page has been configured, the user terminal may adjust the edge region to ensure the accuracy of the configured spatial region or to satisfy the user's personalized requirements. In the process of adjusting the edge region, the user may trigger an adjustment operation on the edge region in the region configuration page through the user terminal, so that the region configuration page may update and display the adjusted target edge region in real time based on the adjustment operation.

Further, information on the configured edge region may be provided by the detection device or another processing end based on the detection information. When the user makes adjustments to the automatically configured edge region, the information on the adjusted target edge region needs to be synchronized to the detection device or the corresponding processing end. Therefore, after the adjustment of the configured edge region is completed, the user terminal may, in response to the user's trigger instruction for the save item in the region configuration page, synchronize the adjusted target edge region to the detection device or another processing end for storage, ensuring the data consistency of the finally configured edge region and spatial region, so as to facilitate subsequent execution of the automatic control scheme.

In the embodiments of the present application, the user may adjust the automatically configured edge region through the region configuration page of the user terminal. When adjusting the edge region, multiple directions of the edge region may be adjusted simultaneously, or each direction may be adjusted separately. The adjustment method is not limited to the color and position of the region; labels, icons, etc. may also be added to the region.

In some embodiments, the user terminal may adjust each edge region individually. For example, the region adjustment process may include:
(A.1.1) obtaining a trigger operation on a currently selected region, displaying a property configuration page for the currently selected region, the property configuration page including a region adjustment item;
(A.1.2) in response to a trigger operation on the region adjustment item, displaying a property selection page corresponding to the region adjustment item;
(A.1.3) obtaining property configuration information selected in the property selection page, and applying the property configuration information to the currently selected region.

Specifically, the user may use any trigger method such as long press, touch, single click or double click on the user terminal to select the region to be configured in the region configuration page. Then the user terminal obtains the currently selected region based on any trigger operation and overlays the property configuration page of the selected region on the region configuration page. The property configuration page may be understood as a function bar containing a region adjustment item. When the user triggers the region adjustment item, the user terminal displays the property selection page corresponding to the region adjustment item. The display process may be realized by jumping between pages or by overlaying the property selection page on the property configuration page. Finally, the user terminal detects the property configuration information selected by the user in the property selection page and configures the selected region based on the property configuration information to complete region adjustment, so that the adjusted target edge region is displayed in the region configuration page.

As an example, after the automatically configured edge region has been completed, if the user wants to adjust the color of the edge region, the user may click, long press or otherwise trigger the edge region to be adjusted in the region configuration page. At this time, the property configuration page for the selected edge region is displayed. As shown in FIG. 10, the property configuration page may include region adjustment items for multiple attributes.

Referring to FIG. 10, region adjustment items include, but are not limited to, color, size and position. The user may select the color region adjustment item in the property configuration page, causing the user terminal interface to jump to or overlay the property selection page corresponding to the color region adjustment item. The color region adjustment item is configured to adjust the color of the selected edge region; the size region adjustment item is configured to adjust the size of the selected edge region; the position region adjustment item is configured to adjust the position of the selected edge region in the target space.

As shown in FIG. 11, the property selection page may include multiple color attributes such as red, green, blue, yellow, purple, black, etc. The user may select one color attribute as the property configuration information, or select multiple color attributes as the property configuration information. When multiple color attributes are selected, a new color attribute may be determined by combining the multiple colors, which is not limited herein. Finally, the property configuration information is configured to adjust the selected edge region.

In some embodiments, the user may adjust the position of the automatically configured edge region by dragging. For example, the region adjustment process may include:
(A.2.1) obtaining a trigger operation on the currently selected edge region and displaying a property configuration page for the currently selected region, the property configuration page including a region adjustment item;
(A.2.2) in response to a trigger operation on the region adjustment item, marking the selected edge region in the region configuration page to obtain a marked edge region;
(A.2.3) in response to a drag command on the marked edge region, updating the display position of the marked edge region in the region configuration page to obtain the adjusted target edge region.

Specifically, the user may use any trigger method—such as long press, touch, single click, or double click—on the user terminal to select the region to be configured in the region configuration page. The user terminal then obtains the currently selected region based on any trigger operation and overlays the property configuration page of the selected region on the region configuration page; the property configuration page may be understood as a function bar containing a region adjustment item. When the user triggers the region adjustment item, the edge region in the region configuration page is marked, i.e., displayed as a marked edge region. Finally, the user may adjust the position of the selected edge region by dragging. The user terminal responds to a drag command on the marked edge region to update the display position of the marked edge region in the region configuration page, thereby completing the position adjustment of the edge region and obtaining the adjusted target edge region.

As an example, after the automatically configured edge region is completed, if the user wishes to adjust the position of the edge region in the region configuration page, the user may click, long press, or otherwise trigger the edge region to be adjusted in the region configuration page. At this point, the property configuration page displayed for the selected edge region may include region adjustment items for multiple attributes-such as color, size, and position. The user may then select the position region adjustment item in the property configuration page. The selected edge region is then marked—e.g., with a dashed frame, bold frame, or highlighted colored frame—to obtain the marked edge region. Finally, the user drags the marked edge region to adjust its position.

In an embodiment of the present application, after the edge region has been configured, the user terminal may set an automatic control scheme for the configured spatial region to enable application in an intelligent automation scene. When deploying the intelligent automatic control scheme, the user terminal may set the automatic control scheme for any position region within the configured spatial region.

In some embodiments, the region configuration page includes a spatial region corresponding to the target space. The deployment process of the automatic control scheme may include: obtaining an arbitrary region selected in the spatial region to generate a customized monitoring region; in response to a selection operation on the monitoring region, displaying a function configuration page for the selected monitoring region; obtaining control attribute information configured in the function configuration page and generating an automatic control scheme for each monitoring region; wherein the configured monitoring region and the edge region are configured to implement automatic control via region based detection.

As an example, the user may select any position region in the spatial region in the region configuration page—such as selecting a certain edge region or multiple edge regions—and designate the selected region as a monitoring region. The user terminal may mark the selected position region as a monitoring region or report the selected position region as a monitoring region. When the user triggers the selection of the monitoring region, the user terminal jumps to or overlays the function configuration page corresponding to the monitoring region on the region configuration page. The function configuration page includes multiple functional attributes.

Taking a smart home scene as an example, assume functional attributes such as lighting, television, air conditioner, and fan are included. When the user selects the control attribute information for the television in the function configuration page, this control attribute information may be sent to the detection device or another processing end to generate an automatic control scheme for the currently selected monitoring region. Subsequently, when the user appears in the monitoring region within the spatial region, the automatic control scheme is executed—for example, the television is automatically turned on for programmer playback.

In addition, when the user terminal configures an automatic control scheme for a region, the entire spatial region may also be selected. For example, after the user selects the entire spatial region and chooses the control attribute information for lighting in the function configuration page, the user terminal configures an automatic control scheme for lighting for the entire spatial region. Subsequently, when a user is detected within the target space, the lighting is automatically controlled to provide illumination.

As another example, assume the user wishes to set an automatic control scheme for an ambient light at a certain wall position in the target space. The user selects an edge region in the spatial region in the region configuration page as a monitoring region and chooses the control attribute information for the ambient light for this monitoring region in the function configuration page to generate the automatic control scheme. When the user appears in this monitoring region in the target space, the ambient light is automatically turned on.

Through the above methods, the user terminal may display the automatically configured edge region in the region configuration page to determine the range of the spatial region corresponding to the target space. By establishing an automatic control scheme within the region in the spatial region, intelligent automatic control of the spatial region or any position within the spatial region may be achieved, thereby improving user experience.

By implementing any one or any combination of the embodiments described above, the application scene of the region configuration process may be realized.

From the above, in the embodiments of the present application, the user terminal may display a region configuration page that includes an edge configuration item; in response to a trigger operation on the edge configuration item, prompt information is generated to instruct the first target object to move in the target space; an automatically generated edge region is displayed on the region configuration page, the edge region is determined based on detection information corresponding to movements of the first target object in the target space, and a trajectory diagram for each space is drawn and displayed based on the trajectory information and the edge region. Thus, the present solution allows the user to participate in configuring the edge region of the space. The user terminal first displays the region configuration page on the interface; then, when the user triggers the edge configuration item in the region configuration page, the user is prompted to move in the target space so that other detection sources may collect detection information while the first target object moves; finally, the automatically generated edge region is displayed in the region configuration page based on the detection information. In this way, through user participation in edge region configuration, the edge region of the space may be determined based on detection information obtained during the user's movement, improving the accuracy of constructing the edge of the spatial region, enhancing reliability, and thereby improving the accuracy of constructing the trajectory diagram.

Based on the methods described in the above embodiments, further detailed descriptions will be given below with examples.

In the embodiments of the present application, data processing is taken as an example to further describe the data processing method provided by the embodiments.

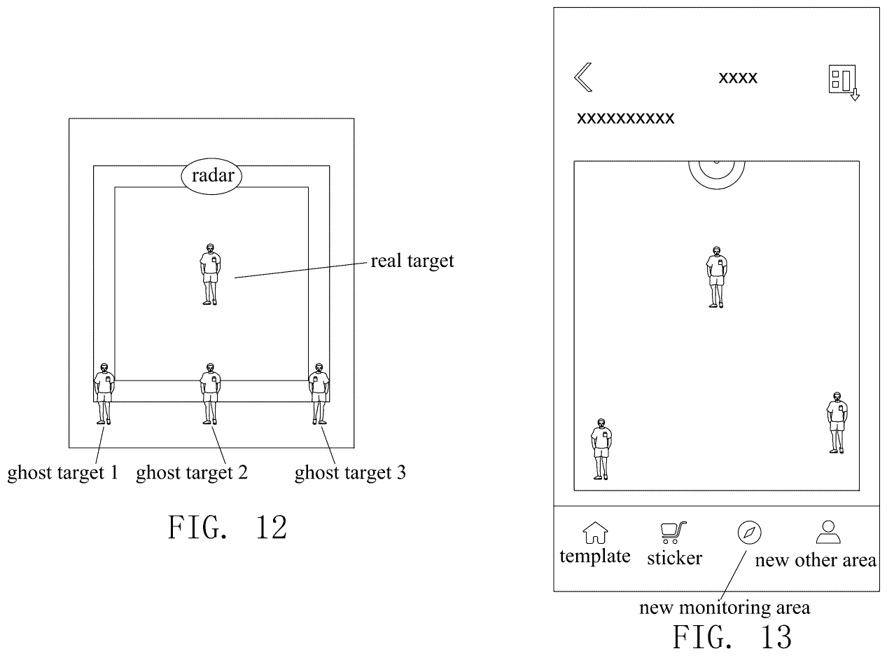

FIG. 12 is an example diagram showing the distribution scene of the first target object and the ghost target in the target space of an embodiment of the present application. FIG. 13 is a page schematic diagram showing the edge region configuration scene of multiple targets of the present application. For ease of understanding, the embodiments will be described in conjunction with FIGS. 12 and 13.

In the embodiments of the present application, the description will be given from the perspective of execution by an electronic device, which may specifically be a detection device, a user terminal, or a server. before displaying the edge region on the region configuration page, the method includes:
obtaining the detection information collected by a detection device based on a detection instruction while the first target object moves in the target space; based on the detection information, determining the position of the first target object in the target space and a position of a ghost target corresponding to the first target object; based on the position of the first target object and the position of the ghost target, determining the edge region corresponding to the target space, wherein the edge region is automatically displayed on the region configuration page in response to the trigger operation on the edge configuration item.

The first target object may be an object capable of moving in the target space, such as a human body, a smart robot, a sweeping robot, etc.

In the embodiments of the present application, in order to deploy an automatic control scheme in the target space and realize an intelligent automatic control scene for relevant devices or functional devices, the spatial range of the target space may first be accurately determined so that the automatic control scheme may be precisely deployed and user experience during execution of the intelligent control scheme may be improved. When determining the spatial range of the target space, the electronic device may determine the edge positions of walls or fences in the target space by collecting detection information on the movement of the first target object in the target space, thereby configuring the spatial region corresponding to the target space.

Therefore, when the user terminal configures the spatial region corresponding to the target space, user participation may be achieved. Specifically, the user may participate in the automatic setting of the edge of the spatial region through the region configuration page displayed on the user terminal device, for example, by opening the region configuration page through a preinstalled region configuration application or a web page on the user terminal. The user may then trigger the edge configuration item in the region configuration page to prompt the first target object to move in the target space.

In addition, the electronic device simultaneously generates a detection instruction, which is generated in response to a trigger operation on the edge configuration item in the region configuration page and is configured to instruct the detection device to collect detection information on the movement of the first target object in the target space.

The detection device may be a human body sensor or a radar device for collecting position information of any target in the target space, such as the position information of the first target object and its associated projection targets. The detection device may implement data collection via point cloud data acquisition.

The detection information may include the position information of the first target object and may also include the position information of the ghost target mapped by the first target object. It should be noted that the ghost target may be a target produced by the first target object under the influence of light or signal echoes. For example, if the detection device is a radar device, when the radar device emits electromagnetic waves, refraction, reflection, scattering and other phenomena occur when the waves encounter the first target object, resulting in ghost targets in the target space—for example, one or more ghost targets corresponding to the first target object appearing on walls or floors. The detection information may be point cloud data and positions.

Through the above methods, the electronic device may collect detection information on the movement of the first target object in the target space so that the positions of the detected targets may later be determined based on the detection information, and the position of the edge region may be further determined based on the positions of the detected targets.

In the embodiments of the present application, after the electronic device collects the detection information on the movement of the first target object in the target space, it may analyze the positions of the first target object and the associated ghost targets in the target space based on the detection information, so that the wall positions in the target space may be determined based on the analyzed positions, thereby completing the configuration of the edge region in the spatial region in the region configuration page.

In some embodiments, the electronic device may determine the real first target object and the corresponding ghost targets based on the distance position relationship between the detected targets and the detection device, thereby obtaining the positions of the real first target object and the ghost targets.

For example, determining the position of the first target object in the target space and the position of the ghost target corresponding to the first target object based on the detection information may include:
identifying positions of targets in the target space based on the detection information, the targets including the first target object and the ghost target;
determining distances between the targets and the detection device based on the positions of the targets;
determining the first target object in the target space and the ghost target corresponding to the first target object, based on the distances between the targets and the detection device, to obtain the position of the first target object and the position of the ghost target.

In some embodiments, the electronic device may distinguish the real first target object and the associated ghost targets based on the distance relationship between the detected targets and the detection device. For example, the step of determining the first target object in the target space and the ghost target corresponding to the first target object based on the distances between the respective targets and the detection device may include: determining a target having the smallest distance to the detection device as the first target object; determining each target other than the first target object as the ghost target corresponding to the first target object.

Specifically, the electronic device determines the position of each detected target based on the detection information and calculates the positional distance between the position of each target and the position of the detection device, thereby determining the distance between each target and the detection device. Further, the electronic device analyzes the real first target object and the corresponding ghost targets from the multiple detected targets based on the distance relationship between each target and the detection device. Then the position of the first target object in the target space and the position of the ghost target in the target space may be obtained. This is configured to subsequently construct the edge region in the spatial region based on the identified positions of the first target object and the ghost target.

It should be noted that, because the first target object is in the target space, refraction, scattering, etc. of the detection signal may produce ghost targets behind or beside the first target object in the target space. However, the real first target object is closer to the radar device than the other ghost targets. Therefore, the real first target object and the ghost targets may be distinguished based on the distance between the detected targets and the detection device.

Specifically, the electronic device finds the target with the smallest distance value based on the distance between each target and the detection device, and determines the target closest to the detection device as the real first target object. Then, the other detected targets in the target space besides the real first target object are determined as the ghost targets associated with the first target object. This is configured to subsequently determine the position of the edge region in combination with the identified positions of the first target object and the ghost targets.

Through the above methods, the electronic device may analyze the positions of the first target object and the associated ghost targets in the target space based on the collected detection information, so that the wall positions in the target space may be determined based on the identified positions of the first target object and the ghost targets, thereby completing the configuration of the edge region in the spatial region in the region configuration page.

In the embodiments of the present application, after the position of the first target object and the position of the ghost target are obtained, the edge region corresponding to the target space—that is, the wall position region—may be determined based on the above positions.

In some embodiments, the edge region corresponding to the target space may be determined based on the positional distribution relationship between the first target object and the ghost targets in the target space. For example, the step of determining the edge region corresponding to the target space based on the position of the first target object and the position of the ghost target may include:
based on the position of the first target object and the position of the ghost target, determining the positional distribution relationship of each ghost target relative to the first target object;
based on the positional distribution relationship, determining the edge position corresponding to each ghost target;
based on the edge position, determining the edge region corresponding to the target space.

The positional distribution relationship includes the positional distribution of each ghost target and the first target object in the target space. Based on this positional distribution relationship, the distance between each ghost target and the first target object may be determined.

Specifically, after obtaining the position of the first target object and the position of the ghost target, the positional distribution relationship of each ghost target relative to the first target object in the target space may be determined based on the positions of the first target object and the ghost targets. Subsequently, when multiple ghost targets exist, each ghost target generally scatters onto the walls within the target space, and the detection device collects the ghost targets via point cloud or other means. Therefore, each ghost target may correspond to a respective cavity within the target space, and the position of the ghost target may be configured to determine the position of the walls within the target space, i.e., the edge positions. Finally, after determining the edge positions corresponding to the target space, the edge region corresponding to the target space may be generated based on the determined edge positions, so that the information data of the edge region may be transmitted to the user terminal and displayed in the region configuration page of the user terminal.

In the embodiments of the present application, the obtained edge region is configured to automatically display in the region configuration page in response to a trigger operation on the edge configuration item. Specifically, after the user triggers the edge configuration item in the region configuration page of the user terminal and instructs the detection device to collect detection information during the movement of the first target object, the detection device or another processing end (such as a server) determines the edge region of the target space based on the positions of the first target object and the ghost targets reflected in the detection information. Thereafter, the detection device or the other processing end transmits the information data of the edge region to the user terminal to automatically display the edge region in the region configuration page, thereby configuring the spatial region corresponding to the target space.

In some embodiments, multiple ghost targets may exist on the same side edge, which may interfere with the determination of the edge position on that side and affect accuracy. Therefore, when multiple ghost targets appear on the same side edge, the electronic device needs to select the ghost targets that conform to the spatial distribution to further determine the edge position. For example, taking the position of the detection device in the target space as the origin, when the first target object is located directly in front of the detection device, the ghost targets may be located on the front wall of the first target object. The step of determining the edge position corresponding to each ghost target based on the positional distribution relationship may include: when it is determined based on the positional distribution relationship that the ghost target is located directly in front of the first target object, determining the ghost target located directly in front of the first target object as a front ghost target; when it is identified that the number of front ghost targets is multiple, determining the position of the front ghost target closest to the first target object as the edge position.

In some embodiments, for ghost targets located on the sidewalls, when determining the edge position, the following may also be included: when it is determined based on the positional distribution relationship that the ghost target is located on the side of the first target object, determining the ghost target located on the side of the first target object as a side ghost target; when it is identified that the number of side ghost targets is multiple, determining the position of the side ghost target closest to the first target object as the edge position.

In the embodiments of the present application, after the edge region is transmitted to the region configuration page of the user terminal for display, when the user adjusts the automatically configured edge region, it is necessary to ensure the information data of the edge region in the detection device or other processing end (such as a server) is consistent. Therefore, after the user terminal completes the adjustment operation on any edge region in the region configuration page, the relevant data of the adjusted target edge region is transmitted to the detection device or the other processing end (such as a server), so that the data of the edge region adjusted by the user is synchronized with the data of the detection device or the other processing end, thereby enabling precise control of the intelligent automatic control scheme in the subsequent process.

In the embodiments of the present application, the user may set an automatic control scheme for the configured spatial region to achieve intelligent control. Specifically, the user selects any region in the spatial region through the region configuration page of the user terminal as a monitoring region, configures relevant control attribute information for the monitoring region, and saves it. Thereafter, the electronic device synchronizes the monitoring region and the control attribute information to the detection device to complete the construction of the automatic control scheme, so that the detection device may perform target detection for the monitoring region. Subsequently, when a target is detected within the monitoring region, the automatic control scheme is executed, for example, automatically controlling the on/off of the lighting to provide illumination.

Through the above methods, the edge region corresponding to the target space may be determined, so that each edge region of the spatial region may be automatically displayed in the region configuration page later, thereby completing the accurate configuration of the spatial region corresponding to the target space.

The region configuration scene of the smart home in the present application may be implemented through the user terminal and the detection device, as detailed below:
(1) Region configuration flow on the user terminal side via interface interaction:
(1.1) After opening the region configuration application on the user terminal, the user terminal displays the edit region interface, which may be regarded as the initial page. As shown in the example in FIG. 6, it includes, without limitation, a function bar and a content display area. The function bar contains items such as “template”, “sticker”, “new monitoring region”, and “new other region”, etc. When the user triggers the “new other region” item, the initial page jumps to the region configuration page, causing the region configuration page to be displayed on the user terminal interface.
(1.2) the region configuration page, as shown in FIG. 7, includes attribute items such as “Interference Source”, “Entrance and exit”, and “edge”. The “edge” control is the edge configuration item. The user may trigger the edge configuration item via the user terminal, and the function bar area may jump to display the edge attribute configuration page, as shown in FIG. 8. The attribute configuration page includes items such as “Color” and “automatic configuration”, etc., which are examples only.
(1.3) when the user triggers the “automatic configuration” item, the automatic configuration region mode is entered. In this mode, prompt information is generated, and the trigger operation on the “automatic configuration” item causes the function bar to jump to the information prompt page, so that the prompt information is displayed in text form on the information prompt page, as shown in FIG. 9. This is configured to instruct the first target object to move in the target space. Additionally, a detection instruction may be generated to instruct the detection device to collect detection information during the movement of the first target object.
(1.4) the user terminal displays the automatically generated edge region in the content display area of the region configuration page. The automatic configuration result of the edge region may be seen in FIG. 10.
(1.5) for the automatically configured edge region, the user may make adjustments via the user terminal to ensure the accuracy of region configuration or to meet personalized requirements. For example, the user may select the “Color” attribute configuration information in the attribute configuration page corresponding to the edge configuration item (FIG. 10), causing the function bar to jump to the attribute selection page corresponding to “Color”, as shown in FIG. 11. The attribute configuration page for “Color” displays multiple colors such as red, green, blue, yellow, purple, and black. If the user selects the “Red” attribute configuration information in the attribute configuration page, the automatically configured edge region is adjusted and displayed in red based on the “Red” attribute configuration information. In addition, the user may also adjust the position of the automatically configured edge region. It should be noted that adjustments to the edge region require synchronizing the adjusted edge region data to the detection device or another processing end.
(2) taking the radar device as the detection device, the edge region determination flow on the detection device side is as follows:
(2.1) the radar device may start detection work based on the detection instruction triggered by the edge adjustment item in the region configuration page, or it may start detection work proactively. During the detection process, the radar device detects the movement of the first target object in the target space to obtain the positions of the detected targets.
(2.2) determining whether the number of detected targets is greater than 1. Here, the number of detected targets refers to the total of the real first target object and the ghost targets. If the number of detected targets is greater than 1, obtain the positions of each detected target and take the target closest to the radar device as the real target.
(2.3) edge position determination process:
(2.3.a) in the target space, when there is a wall behind the real first target object, a ghost target 1 appears directly behind the first target object (the target with the smallest distance from the radar device in the x direction), and this ghost target 1 is configured to determine the wall directly in front of the radar, i.e., the front edge position.
(2.3.b) if the target space includes walls in multiple directions, ghost targets in multiple directions may appear, i.e., the number of detected targets is greater than 2. In this case, the position of each detected target is obtained separately. If there is a wall directly behind the real first target object, there will be ghost target 1 directly behind the real first target object, and this ghost target 1 is configured to determine the edge position directly in front of the radar.

Further, ghost targets 2 and 3 appear on the walls to the left and right of ghost target 1, respectively. The distribution relationship of ghost targets 1, 2, and 3 in the target space is shown in FIG. 12. At this time, the ghost target closest to ghost target 1 is taken as the left and right wall positions, i.e., the left and right edge positions. The resulting region configuration result is shown in FIG. 13.
(3) after region configuration is completed, the user terminal may deploy an automatic control scheme for the configured spatial region and monitor the spatial region via the detection device. When the first target object is detected and the detected condition of the first target object satisfies the trigger condition of the automatic control scheme, the corresponding device is controlled to execute the corresponding automatic control scheme.

Through the above application scene examples, the following effects may be achieved: automatic configuration of regions via user interface interaction-users only need to leave the room or walk within the room as required to complete configuration, which is simple and practical; false interference targets affecting region configuration may be effectively suppressed, the method is simple and highly accurate; it is applicable to the deployment of automatic control schemes for spaces, enabling intelligent control of spaces.

From the above, in the embodiments of the present application, users may participate in configuring the edge region of the space. First, the region configuration page is displayed on the interface; then, when the user triggers the edge configuration item in the region configuration page, the user is prompted to move in the target space so that other detection sources may collect detection information while the first target object moves; finally, the automatically generated edge region is displayed in the region configuration page based on the detection information. In this way, through user participation in edge region configuration, the edge region of the space is determined based on detection information obtained during the user's movement, improving the accuracy of constructing the edge of the spatial region, thereby improving the accuracy of constructing the trajectory diagram and the spatial layout diagram, with high reliability.

Refer to FIG. 14, which is a flowchart of a spatial configuration method shown of an exemplary embodiment. The method is applicable to an electronic device, which may specifically be the user terminal 110 shown in the implementation environment of FIG. 1.

In the following method embodiments, for ease of description, the electronic device is taken as the executing entity of each step by way of example, but this is not intended as a specific limitation. The spatial configuration method includes the following steps:

Step 1401: displaying a spatial configuration page; the spatial configuration page including a spatial region; wherein the spatial region includes a region from a spatial layout diagram corresponding to a target space, the spatial layout diagram is obtained from trajectory information of a first target object within each space of the target space and an entrance and exit position of each space, the spatial layout diagram is configured to display previously added second target objects at corresponding positions.

The spatial configuration page refers to a user interface that may interact with the user for configuring an intelligent space template. Thus, when the user wishes to configure an intelligent space template, the client is started and the user enters the user interface for configuring the intelligent space template, which is regarded as displaying the spatial configuration page. The user may configure, via the user terminal on the spatial configuration page, the spatial region in the spatial layout diagram corresponding to the target space, each second target object displayed at corresponding positions in the spatial layout diagram corresponding to the target space, and the corresponding device control scheme, to generate the corresponding intelligent space template.

The target space is the space currently requiring intelligent space template configuration, and may be, but is not limited to, a room, a household, a floor, a building, or other home or office spaces. The spatial region is an attribute of the spatial layout diagram corresponding to the target space, configured to indicate the distribution of the target space, including but not limited to including regions in the spatial layout diagram corresponding to the target space. If the spatial layout diagram is a floor plan diagram, the spatial region includes regions in the floor plan diagram, and the size and distribution of the spaces in the floor plan diagram corresponding to the target space may correspond to the size and distribution of the target space. It may be understood that the spatial region corresponding to the target space may be generated through auxiliary recognition by the user terminal or manually configured by the user via the user terminal, without limitation herein.

The second target object is a device capable of realizing automatic scene control, specifically, smart home devices such as lamps, televisions, air conditioners, curtains, fans, etc. Each second target object located within the target space corresponds to a different position. The user may input an addition operation for a selected second target object on the spatial configuration page via the user terminal, so that the user terminal may add the selected second target object to the corresponding position in the spatial region based on the received addition operation, and display the added second target object at the corresponding position. It may be understood that each second target object may be manually added to the spatial region by the user or automatically generated based on device information. The second target objects displayed in the spatial configuration page may specifically be device identifiers of the second target objects, which may be device names, etc., and may be identified by icons and/or text.

Step 1402: displaying a generated device control scheme in a scheme presentation area of the spatial configuration page; wherein a device control scheme is generated by matching relationships among second target objects in the target space.

The user terminal may generate the device control scheme by matching relationships among the second target objects under the target space and display the generated device control scheme in the scheme presentation area of the spatial configuration page for the user to understand and adjust in a timely manner. For example, the device control scheme may be “When the entrance door is opened, turn on the living room light”.

Step 1403: in response to a save operation on a selected device control scheme, generating an intelligent space template based on the device control scheme; wherein the intelligent space template is configured for match application to spaces compatible with the target space.

The spatial configuration page and/or the user terminal may provide a save button for triggering storage of the space template. After the save button is triggered, the user terminal correspondingly obtains the save operation for the spatial configuration page and generates an intelligent space template that may be used for match application to spaces compatible with the target space based on the second target objects under the spatial region and the respective device control schemes.

The intelligent space template refers to a template pre-configured for the spatial region corresponding to the target space and the devices under the target space. When the intelligent space template is applied to a space compatible with the target space, the corresponding devices in the compatible space will have the various functions in the intelligent space template. The space compatible with the target space may specifically be a space whose spatial region is the same as that of the target space, such as a space with the same floor plan as the target space.

Taking the target space as a home area, the spatial layout diagram as a home floor plan, and the spatial region as the region corresponding to the user's home floor plan as an example, the configuration process of the intelligent space template mainly includes: the user terminal builds a digital home functional floor plan region, stores the home floor plan, adds devices to the home area, stores the relationship between the home floor plan and the devices, adds automation relationships between devices, stores the automation relationships between devices, receives a save operation, and stores the home floor plan, the relationship between the home floor plan and the devices, and the automation relationships between devices as a callable space template. Through the above operations, after the user completes the configuration of a home space, the user terminal may pull the corresponding data based on the home floor plan configured by the user in the smart system, the device position relationships, and the automation configuration information, and save it as a separately packaged template data when the user clicks the “Save as template” button, thereby completing the configuration of the intelligent space template.

In the above embodiments of the present application, precise matching between the spatial region corresponding to the target space, the second target objects, and the device control schemes may be realized, and the intelligent space template corresponding to the target space may be generated. Thus, the intelligent space template may be applied to spaces compatible with the target space, avoiding repeated configuration of the same or similar spaces, effectively reducing configuration complexity, and effectively improving configuration efficiency.

In some embodiments, displaying the spatial configuration page includes: displaying the spatial configuration page, and displaying, in the spatial configuration page, a spatial region corresponding to the target space determined based on region layout data; the region layout data is obtained by processing signals collected from the target space by an auxiliary recognition device.

The region layout data refers to layout data of respective regions within the target space and may specifically be configured to describe the relative positions and layout of the respective regions within the target space. Taking the target space as a residential house as an example, the corresponding region layout data may include the positions of the respective room regions included in the residential house and the layout of each room region.

When it is necessary to obtain the spatial region corresponding to the target space, the user terminal may collect the target space with the aid of an auxiliary recognition device to obtain region layout data, and then determine the spatial region corresponding to the target space based on the region layout data.

It may be understood that the auxiliary recognition device may be configured as needed, for example as a radar ranging sensor, a millimeter wave radar human presence sensor, an image capture device, etc. Taking the auxiliary recognition device including a millimeter wave radar human presence sensor as an example, when the user walks within the target space following the regional distribution of the target space, the millimeter wave radar human presence sensor may be configured to perform human form tracking of the user; processing the collected signals yields region layout data, such as the position data of the target space in the radar coordinate system, and the spatial region corresponding to the target space may then be determined based on the region layout data.

In the present embodiment, by obtaining the region layout data of the target space via the auxiliary recognition device and determining the spatial region corresponding to the target space based on the region layout data, the spatial region corresponding to the target space may be accurately obtained with convenient operation, further reducing configuration complexity.

In some embodiments, the above spatial configuration method further includes: in response to any region selected on the spatial configuration page, generating a custom region; determining the custom region as the spatial region corresponding to the target space; the spatial region includes at least one.

Displaying the generated device control scheme in the scheme presentation area of the spatial configuration page includes: in response to a selection operation on the spatial region, displaying, in the scheme presentation area of the spatial configuration page, the device control scheme corresponding to the selected spatial region based on the second target objects already bound under the target space.

The spatial configuration page may provide the user with a function of custom setting the spatial region corresponding to the target space; the spatial region may include at least one, and the function of each spatial region may differ. Taking the target space as a family residence as an example, the spatial regions corresponding to the target space may by function include a bedroom, a living room, a kitchen, a bathroom, etc. The user terminal responds to any region selected by the user on the spatial configuration page to generate a custom region and determines the custom region as the spatial region corresponding to the target space.

It may be understood that the user may select any one region on the spatial configuration page each time, or may select multiple regions on the spatial configuration page each time, which is not specifically limited herein. In addition, the manner in which the user selects regions on the spatial configuration page via the user terminal may specifically be by frame selection with a region selection box or editing with a brush, etc.

Because the function corresponding to each spatial region may differ, the included second target objects may also differ. For example, for the living room region, the included second target objects may include a television and curtains, whereas for the bathroom region, the included second target objects may include a smart toilet and an exhaust fan. Therefore, for each selected spatial region, the user terminal needs to first determine the second target objects included in the selected spatial region based on the second target objects already bound under the target space, then obtain the linkage relationships among the second target objects included in the selected spatial region, i.e., the device control scheme corresponding to the selected spatial region. Then the user terminal displays, in the scheme presentation area of the spatial configuration page, the device control scheme corresponding to the selected spatial region.

In the present embodiment, by displaying the device control scheme corresponding to the selected spatial region in the scheme presentation area of the spatial configuration page based on the second target objects already bound under the target space, the user terminal enables the user to conveniently understand the device control scheme corresponding to each spatial region and facilitates adjustment of the device control scheme corresponding to each spatial region, further improving configuration efficiency.

In some embodiments, displaying the generated device control scheme in the scheme presentation area of the spatial configuration page includes:
obtaining the positional relationships between the target space and each second target object, and the device relationships among the second target objects;
generating the device control scheme corresponding to each spatial region based on the positional relationships and the device relationships, and displaying the device control scheme in the scheme presentation area of the spatial configuration page.

It may be understood that the user terminal may obtain the positional relationships between the target space and each second target object based on the positions at which the second target objects are displayed in the spatial region corresponding to the target space. The device relationships among the second target objects are configured to indicate the conditions required for the second target objects to realize automatic control scenes and their mutual associations, including but not limited to control and controlled relationships, relationships for sensing the environment to determine whether trigger conditions are met and executing actions, etc. Based on the positional relationships between the target space and each second target object, the user terminal may learn the second target objects included in each spatial region, and based on the device relationships among the second target objects, may learn the device attributes of the second target objects, such as the trigger device and the controlled device linked to the trigger device. Therefore, the user terminal may obtain the device attributes of the second target objects included in each spatial region based on the positional relationships and the device relationships, and may then generate the device control scheme corresponding to each spatial region based on the device attributes of the second target objects included in each spatial region, and display the device control scheme in the scheme presentation area of the spatial configuration page.

The user terminal may display the device control scheme corresponding to each spatial region in the scheme presentation area of the spatial configuration page, or may display only the device control scheme corresponding to a single spatial region. The device control schemes corresponding to the other spatial regions may be hidden by default and displayed only after are triggered, thereby avoiding occupying excessive display area of the spatial configuration page.

In the present embodiment, by generating and displaying the device control scheme corresponding to each spatial region based on the positional relationships between the target space and the second target objects and the device relationships among the second target objects, the user terminal may accurately obtain the device control scheme corresponding to each spatial region with simple operation, further reducing configuration complexity.

In some embodiments, displaying the generated device control scheme in the scheme presentation area of the spatial configuration page includes:
obtaining historical control data of each second target object;
determining trigger conditions and execution actions corresponding to each second target object having a linkage relationship in the target space, based on the positional relationships among the second target objects, the device relationships among the second target objects, and the historical control data;
generating the device control scheme corresponding to each spatial region based on the trigger conditions and the execution actions corresponding to each second target object.

The user terminal may obtain the historical control data of each second target object recorded by itself or a server. Historical control data refers to data generated or recorded from historical control of the second target objects, and may include trigger times, trigger conditions, executed actions, etc. of the second target objects. For example, taking the second target objects including the bedroom curtain and the bedroom lamp as an example, if the historical control data records that after the bedroom door is opened, the bedroom lamp is turned on, and then the bedroom curtain is usually opened shortly thereafter, the user terminal may determine that there is a linkage relationship between the bedroom lamp and the bedroom curtain, with the trigger condition for the bedroom lamp is the opening of the bedroom door and the execution action is turning on the light, etc.

Therefore, the user terminal may first determine the trigger conditions and executed actions corresponding to each second target object having a linkage relationship under the target space based on the positional relationships, the device relationships, and the historical control data, as well as the second target objects included in each spatial region, and then generate the device control scheme corresponding to each spatial region based on the trigger conditions and executed actions corresponding to each second target object, combined with the second target objects included in each spatial region. The trigger condition is the condition that may be satisfied for the second target object to perform the action, and the execution action is the control instruction executed by the second target object when the trigger condition is met.

For example, for the device control scheme “curtain open, lamp off”, there is a linkage relationship between the curtain and the lamp. The trigger condition for the lamp is the curtain opening, and the corresponding execution action is turning on the lamp.

In the present embodiment, the user terminal generates the device control scheme corresponding to each spatial region by combining the historical control data of the second target objects, enabling accurate acquisition of the device control scheme corresponding to each spatial region with high accuracy and convenient operation, further reducing configuration complexity and improving configuration efficiency.

In some embodiments, the above spatial configuration method further includes:
in response to an adjustment instruction for a device control scheme, updating the device control scheme based on the control adjustment information corresponding to the adjustment instruction;
displaying the updated device control scheme on the spatial configuration page.

The user may need to adjust the device control scheme based on actual conditions such as personal requirements and may accordingly input an adjustment instruction for the device control scheme to the user terminal. The user terminal responds to the adjustment instruction for the device control scheme, updates the device control scheme based on the control adjustment information corresponding to the adjustment instruction, and displays the updated device control scheme on the spatial configuration page.

The user may perform long press, double click, or other touch operations on the device control scheme displayed on the spatial configuration page via the user terminal, thereby causing the user terminal to enter a state of receiving the adjustment instruction. Alternatively, the spatial configuration page may include a key for adjusting the device control scheme; when the key is triggered, the user terminal enters the state of receiving the adjustment instruction.

For example, assuming the device control scheme includes an automatic control scheme, and the automatic control scheme includes a trigger condition and an execution action, if the automatic control scheme is “when the entrance door opens, turn on the living room light,” and the user adjusts the execution action, the adjustment instruction input to the user terminal is to change “turn on the living room light” to “turn on the hallway light,” then the updated automatic control scheme is “when the entrance door opens, turn on the hallway light.” If the user adjusts the trigger condition, and the adjustment instruction input to the user terminal is to change “when the entrance door opens” to “when the bedroom door opens,” then the updated automatic control scheme is “when the bedroom door opens, turn on the hallway light.”

In the present embodiment, the user may adaptively adjust the device control scheme based on needs, making the device control scheme better suited to user requirements, enhancing user experience, and further improving configuration efficiency.

In some embodiments, after generating the intelligent space template, the above spatial configuration method further includes:
obtaining a geographical position corresponding to the target space;
sharing the intelligent space template to a spatial template collection corresponding to the geographical position; wherein the spatial template collection is configured to push each intelligent space template within the spatial template collection to a target terminal satisfying a push condition, based on the geographical position, wherein the intelligent space template is configured to recommend a template to the target terminal satisfying the push condition based on the geographical position of the target space, so as to instruct the target terminal to display a recommended intelligent space template based on a current geographical position for application; each intelligent space template includes spatial regions of a template space and device control schemes adapted for the second target object deployable in the template space.

The spatial template collection refers to a collection composed of a plurality of intelligent space templates having the same geographical position. The spatial regions corresponding to different intelligent space templates within the same spatial template collection may be the same or different.

For example, taking the geographical position as the name of a residential community, the spatial template collection corresponding to the community name may include an intelligent space template of Type A layout and may also include an intelligent space template of Type B layout. The user terminal may obtain the geographical position corresponding to the target space by activating the position function and collecting the current geographical position through an installed navigation system such as GPS or BeiDou, and determining the collected current geographical position as the geographical position corresponding to the target space. Alternatively, the user terminal may obtain a position input by the user and determine the user input position as the geographical position corresponding to the target space.

The geographical position may be configured to indicate the position of the target space, and may specifically be latitude and longitude or the name of a community, building, or office building. The spatial template collection may be stored in a cloud server. Accordingly, the user terminal sharing the intelligent space template to the spatial template collection corresponding to the geographical position may involve the user terminal sending the intelligent space template and the geographical position to the cloud server, so that after the cloud server receives the intelligent space template, it stores the intelligent space template to the spatial template collection corresponding to the geographical position based on the geographical position.

The push condition may be set as needed, such as the same or similar geographical position. For example, if the geographical position where the target terminal is located is the same as the geographical position corresponding to the target space, the user terminal may push the intelligent space template to the target terminal. Or, if the geographical position where the target terminal is located is the same as the geographical position corresponding to the target space, and the spatial region corresponding to the space where the target terminal is located is the same as the spatial region corresponding to the target space, the user terminal may push the intelligent space template to the target terminal.

In the present embodiment, the user terminal shares the intelligent space template of the target space to the spatial template collection corresponding to the geographical position of the target space, so that each intelligent space template in the spatial template collection may be pushed to a target terminal satisfying the push condition based on the geographical position, facilitating rapid invocation and recommendation of intelligent space templates, and further improving configuration efficiency.

The target terminal is a user terminal that needs to configure the second target objects within a space, and the push condition may be that the geographical position where the target terminal is located or the geographical position sent by the target terminal is the same as the geographical position where the target space is located. The template space refers to the space that each intelligent space template may adapt to.

It may be understood that when the user terminal receives a spatial template recommendation request sent by the target terminal carrying the current geographical position, it may match the current geographical position with the geographical positions corresponding to the different intelligent space templates to recommend to the target terminal the intelligent space template matching the current geographical position, thereby causing the target terminal to display the intelligent space template recommended based on the current geographical position, such as different intelligent space templates for a certain layout or different intelligent space templates for a certain room.

After the user of the target terminal selects the required intelligent space template and performs an application operation on the intelligent space template, the spatial region, the second target object information, and the corresponding device control scheme under the intelligent space template are delivered to the smart home system associated with the target terminal, so that the smart home system associated with the target terminal uses the intelligent space template for spatial configuration, i.e., uses the intelligent space template to configure the second target objects in the space located in the same spatial region. In this way, the intelligent space template may be repeatedly applied to spaces compatible with the target space, eliminating the need to repeatedly perform spatial configuration operations, avoiding multiple configurations of the same or similar spaces, effectively reducing configuration complexity, effectively improving configuration efficiency, and providing convenient application.

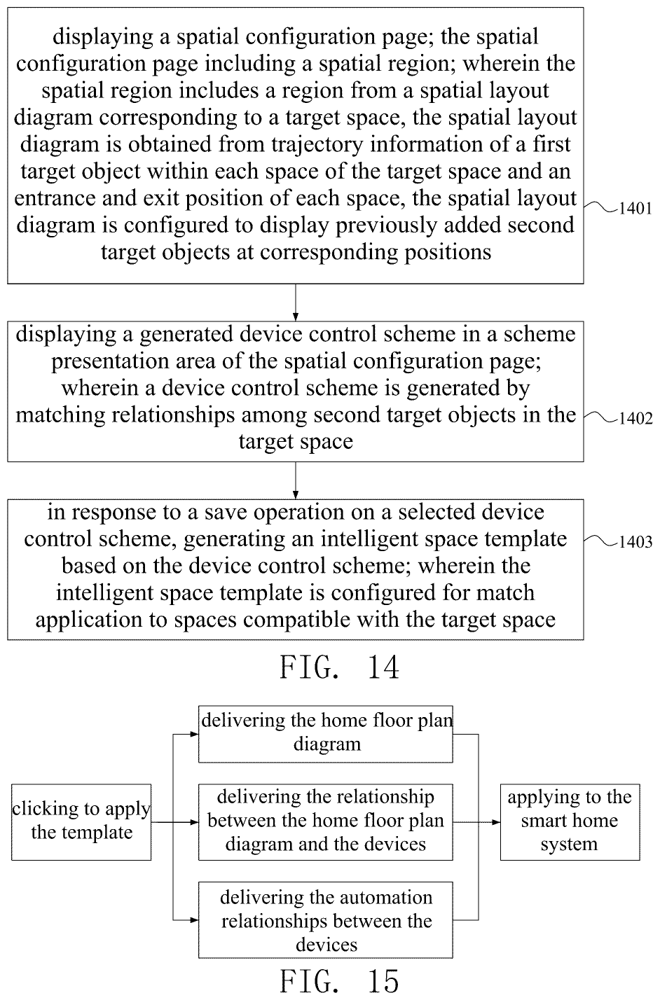

As shown in FIG. 15, taking the target space as a home area and the spatial region as the region corresponding to the floor plan diagram as an example, the application process of the above intelligent space template mainly includes: clicking to apply the template, sequentially delivering the home floor plan diagram, the relationship between the home floor plan diagram and the devices, and the automation relationships between the devices, and applying them to the smart home system. Here, after the intelligent space template containing the relevant floor plan diagram, the relationship between the floor plan diagram and the devices, and the intelligent related information is presented on the front end operation interface of the user's mobile phone, the user may select the required intelligent home template based on the household situation. After clicking to apply the template, the floor plan diagram, the relationship between the floor plan diagram and the devices, and the intelligent related information contained in the template are sent to the user's current smart home system to complete the application of the intelligent space target.

The specific manner of the spatial configuration method is illustrated below with reference to FIG. 1. Taking the target space as the living room and the spatial region as the region in the floor plan diagram as an example, suppose user A uses the user terminal 110 to configure the living room a of their home. The second target objects in living room a include a ceiling light, curtains, a television, a door, etc. After obtaining the floor plan diagram of living room a, by matching the relationships among the second target objects, the device control schemes “open the door, then turn on the ceiling light” and “turn on the television, then close the curtains” are generated. Based on the above information, the intelligent space template for living room a is generated and shared to the spatial template collection corresponding to the geographical position of user A's residential community in the server 170. If user B, who is in the same residential community as user A, needs to configure their living room b, user B may use another user terminal to send a living room template recommendation request carrying the geographical position of the residential community to the server 170. After the server 170 receives the living room template recommendation request, it may push the intelligent space template of living room a to the other user terminal. When user B selects and applies the intelligent space template of living room a, the intelligent space template of living room a is configured to configure the second target objects in living room b, so as to realize in living room b the effects “open the door, then turn on the ceiling light” and “turn on the television, then close the curtains,” so that user B does not need to separately configure living room b, improving user experience.

In order to enable a more systematic understanding of the spatial configuration method provided by the embodiments of the present application, a specific example is illustrated below, taking the spatial region as a floor plan diagram in this example.

Generally, smart home configuration involves three layers of data: floor plan relationships, devices, and intelligent configuration. These data items make smart home configuration relatively difficult. In particular, current technology may gradually provide precise household floor plan data for smart home systems (for example, based on millimeter wave radar to provide household functional area data), but for ordinary home users, the configuration is complex and time consuming.

To provide users with a more convenient solution, based on the fact that intelligent related data already has relevant real time data storage capability in smart systems, the configured devices, household functional areas, and intelligent related data may be saved as a template. The user may select one or more regions to be saved, click “Save as template,” and then generate the devices, household functional areas, and intelligent data contained in the spatial region into a single spatial template for subsequent invocation.

Referring to the drawings, the spatial configuration method in the present application may specifically include the following steps:
obtaining the household floor plan diagram; configuring the positions of the second target objects in each functional area of the household; building the device control scheme for each area of the household; in response to a save operation, generating the intelligent space template; recommending and applying the intelligent space template.

Multiple approaches exist for obtaining the household floor plan diagram, including manual configuration and automatic configuration.

Method 1: Manually configure each room region in the household to obtain the household floor plan diagram.

The user may employ a series of auxiliary recognition devices to acquire the positional distribution relationships between each household room region and the coordinate system of the smart system, thereby establishing the corresponding household floor plan diagram within the smart system coordinate system. For example, a millimeter wave radar human presence sensor may be adopted to perform human form tracking in each room, so as to obtain the positional relationships of the various areas of every room under the radar coordinate system, thus obtaining the floor plan diagram of each room.

Specifically, the millimeter wave radar human presence sensor emits signals and then receives echo signals to track the target object; based on the movement trajectories of the target object in the respective sub spaces and the entrance and exit positional relationships of the sub spaces, a floor plan diagram under the radar coordinate coverage is drawn and generated.

As shown in FIG. 16, taking the acquisition of the bathroom floor plan as an example, when the user performs a long press and/or drag operation with a finger in the spatial region on the spatial configuration interface, the configuration of the bathroom region is triggered. The millimeter wave radar human presence sensor performs human form tracking of the user walking inside the bathroom, thereby obtaining the positional relationships of the various areas of the bathroom under the radar coordinate system—such as the toilet area and the bathing area—thus generating the bathroom floor plan diagram.

template saving and application after spatial position recognition include, without limitation, floor plan diagrams provided by millimeter wave radar; therefore, any floor plan diagram that may be acquired by any device capable of providing floor plan diagrams may serve as this digital floor plan provider, and no exhaustive enumeration is given here.

Method 2: Generate the household floor plan diagram based on a floor plan file.

The user terminal imports a floor plan file into a floor plan recognition system; the floor plan recognition system may rapidly convert the floor plan file into a digital floor plan diagram, automatically obtaining the distribution of household room regions—that is, the household floor plan diagram—and may quickly generate the matching relationship between the smart system coordinate system and the user's home environment.

Method 3: Locate a geographical position and generate the household floor plan diagram.

When the user uses or saves a floor plan template via the user terminal, the smart system in the user terminal automatically pulls the geographical position information of the household where the template is located. As the number of household users continues to increase, the smart system will obtain more and more floor plan diagrams tagged with household geographical position information. The user terminal specifically classifies household floor plan diagrams by geographical position, compares the generation positions of the floor plan diagrams with community distributions in a map system, performs similarity analysis on floor plan templates whose geographical positions are close, and then performs overlap analysis on floor plan templates with high similarity, so as to take the parts with high overlap among multiple floor plan templates as the standard floor plan template for the community. Through continuous accumulation of floor plan templates, the standard floor plan template for the same community will gradually become refined, thereby forming the floor plan template corresponding to the geographical position, and thus the floor plan corresponding to the geographical position may be obtained based on the geographical position.

After completing the household floor plan configuration, the smart system has a good understanding of the user's household floor plan, but has no effective knowledge of the devices in each functional area of the household. At this time, by annotating the positions of devices and facilities on the generated household floor plan, the household floor plan environment is perfected.

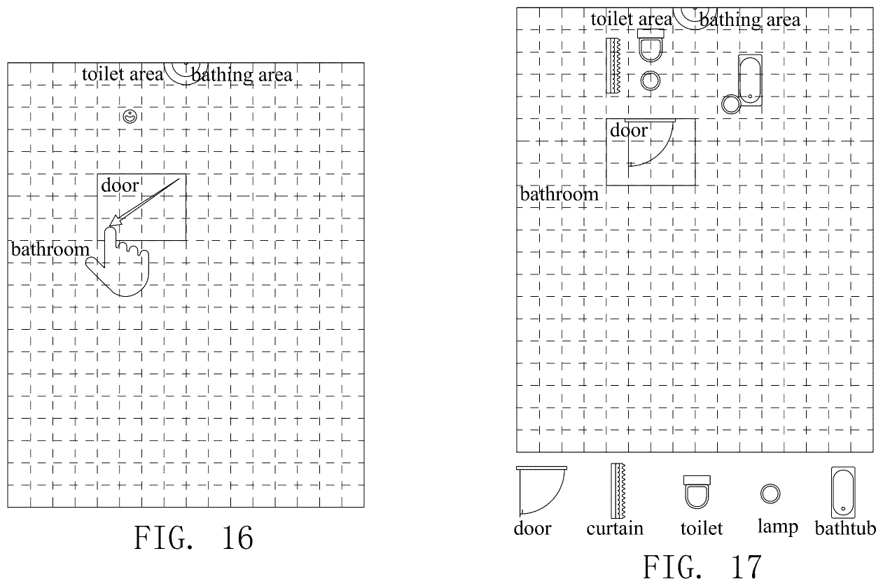

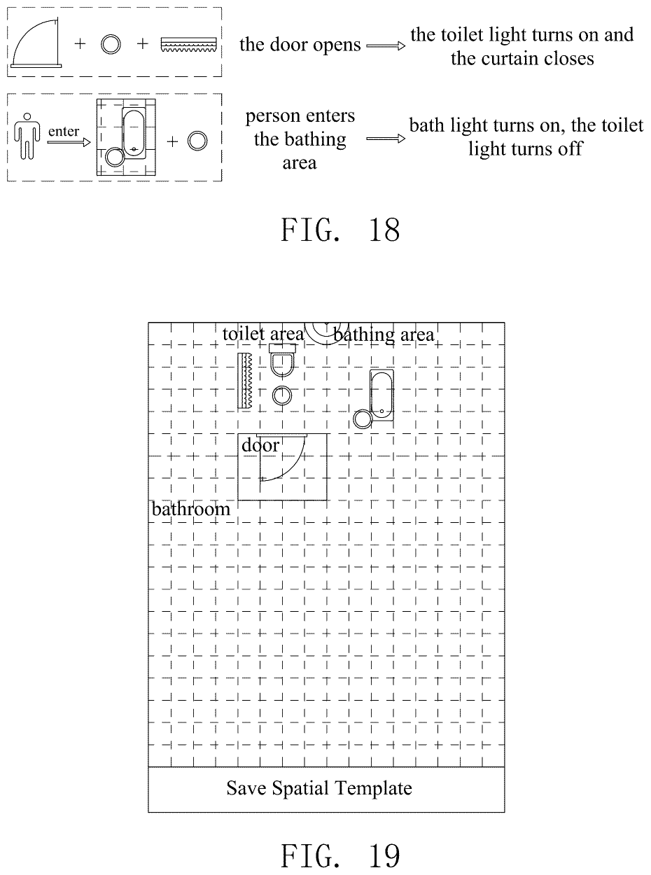

As shown in FIG. 17, taking the configuration of devices in the bathroom as an example, and assuming the bathroom includes a toilet area and a bathing area, the user terminal may display device icons and/or facility icons related to the bathroom on the spatial configuration interface, such as door, curtain, toilet, lamp, and bathtub. The user may select a certain device icon via the user terminal and drag it to the corresponding position in the bathroom to annotate the device position-specifically, the toilet may be annotated in the toilet area, and the bathtub may be annotated in the bathing area.

After completing the device configuration operation, the smart system in the user terminal has a detailed digital understanding of the user's overall household environment, which provides a good reference for the household intelligent space template during subsequent intelligent service control. For example, after the user terminal establishes a floor plan model under the millimeter wave radar coordinate system, it uses human positioning capability to obtain the specific positions of each device in the room, supplements them into the household floor plan, and thus the smart system obtains a complete household floor plan with household device information.

After obtaining the household floor plan and the home environment (i.e., device positions), the user terminal may, based on household scene needs, select devices in the intelligent scene and build area scene automatic control schemes for different household environments, thereby perfecting the smart system capability. During the process of configuring or automatically generating a spatial template, the user terminal may automatically generate a matching device control scheme based on the devices in the household scene.

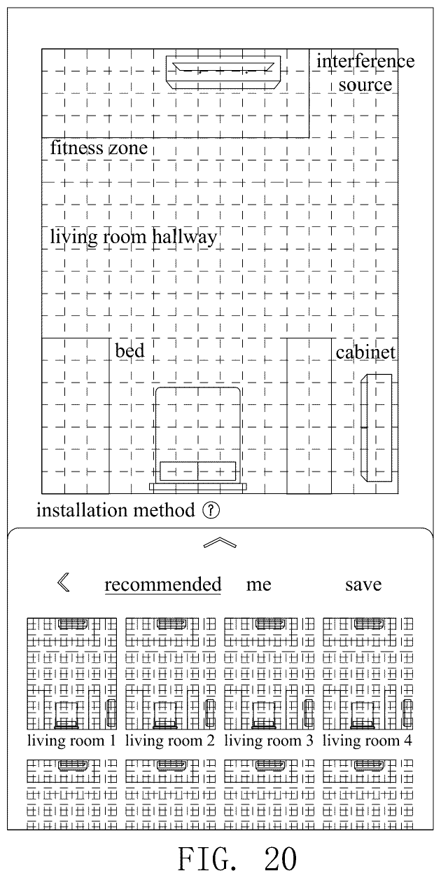

As shown in FIG. 18, taking the configuration of the bathroom device control scheme as an example, the user terminal may provide a device control template on the spatial configuration interface. The device control template may include trigger devices, trigger methods, and controlled devices. By editing the device control template based on actual needs, the corresponding device control scheme may be obtained.

For example, the device control scheme “when the toilet door opens, then the toilet light turns on and the curtain closes” may be set, where the trigger device is the toilet door, the trigger method is opening, and the controlled devices are the toilet light and the curtain. Another example is the device control scheme “when a person enters the bathing area, then the bath light turns on, the toilet light turns off, and the curtain closes,” where the trigger device is a human detection sensor, the trigger method is detecting a person, and the controlled devices are the bath light, the toilet light, and the curtain.

As shown in FIG. 19, after configuration is complete, the user taps the “Save Spatial template” control displayed on the spatial configuration interface of the user terminal to generate the intelligent space template. Meanwhile, once the user terminal has obtained the household position information entered by the user or has been authorized to acquire the current position, it merges the household environment floor plan data that contains device information, the device control scheme, and the household position information into a single intelligent space template for later rapid invocation.

Through the foregoing steps the user terminal obtains an accurate intelligent space template. For individual users, the template that they personally edited-better reflecting real household usage—may be stored. For system service providers, standardized spatial templates that match local community floor plans may be pre imported to help users deploy quickly, and identical templates may be reused for similar floor plans throughout the same community.

By analyzing the floor plans of users in a given region, the system service provider may designate certain intelligent space templates that match the local community as standard templates for recommendation.

As shown in FIG. 20, when a user needs to configure the living room, the user may request, via the user terminal, an intelligent space template recommended for the current position. The service provider then recommends to the user multiple living room intelligent space templates-Living Room 1, Living Room 2, etc.—that match the user's current position. The user selects the desired template through the user terminal, and the precise spatial data (floor plan, device positions, and device control scheme) of the chosen template are imported into the user's current account, enabling immediate application. After application, the user may still edit the template so that it better fits the household environment.

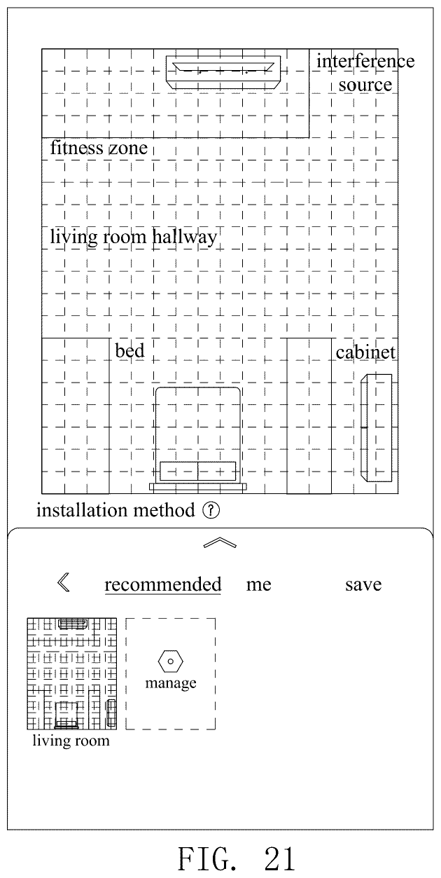

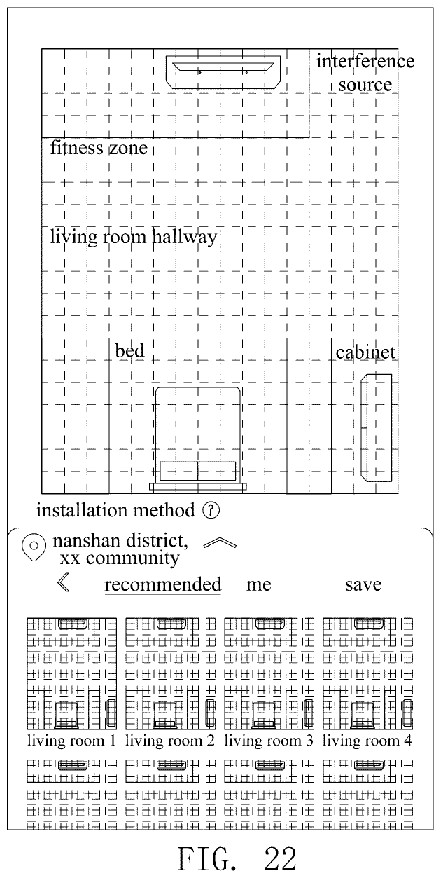

Personally saved intelligent space templates may be viewed quickly by logging into the personal account. As shown in FIG. 21, the user may view the living room intelligent space templates that have been selected and saved. The user simply applies the saved template via the user terminal; the corresponding floor plan, device positions, and device control scheme are automatically loaded without any secondary setup.

Given today's real estate development model, floor plans within the same community are usually fixed; only a few template sets are needed to cover all households. Based on the digitized floor plans, the positions of second target objects and the automation configuration schemes may be designed and then packaged into intelligent space templates. During subsequent use, users may directly select an existing template for immediate application, eliminating repeated household environment and automation relation setup. This not only lowers implementation complexity but also, thanks to the precise digitized household spatial relationships, greatly improves the accuracy of the smart system and the user's intelligent experience.

Because the digitized intelligent space template may be stored together with household position information, the templates may be classified and recommended to users of smart systems in the corresponding position areas. As shown in FIG. 22, when the obtained position is “xx Community, Nanshan District,” the user terminal may recommend different living room intelligent space templates for that community, allowing the user to choose the required template. Thus, position based standard templates have higher floor plan matching accuracy, enabling users to select matching templates more efficiently and apply them to establish a smart home system rapidly.

Accordingly, the spatial configuration method provided by the foregoing embodiments uses auxiliary recognition devices (e.g., millimeter wave radar) to achieve precise matching among household floor plans, devices, and intelligent configuration relationships, and then packages them into templates for storage. This avoids repeated configuration of identical household spaces by individual or enterprise users, reduces smart space configuration complexity, and significantly improves batch intelligent configuration efficiency for similar spaces. The spatial configuration method therefore yields the following technical effects:
(1) The intelligent space template of the household floor plan is saved. Even if devices are relocated or re installed, the matching intelligent space template may be invoked immediately without repeating the complex region configuration workflow.
(2) The template mechanism stored under the account ensures that newly connected devices may quickly obtain existing templates without starting configuration from scratch, improving application convenience.
(3) In projects such as communities where household floor plans are numerous, templates eliminate repeated household floor plan and automation configuration, making intelligent implementation more convenient.
(4) Similarity matching of user household templates in the same region enables intelligent inference of regional floor plans, thereby providing services that suit the user's environment.

In one embodiment, the intelligent space template is also configured to configure device control services for smart devices in the template space. The intelligent space template may include, without limitation, functional regions in the target space, devices, and the corresponding device control services provided for those devices. A functional region indicates the purpose of a region in the target space; the functional region may include at least one region of the spatial layout diagram corresponding to the target space. For example, a functional region named “Sofa Area” indicates that the region is configured for rest.

In one embodiment, after step 1403: responding to the save operation on the selected device control scheme and generating the intelligent space template based on the device control schemes, the method may further include:
displaying a template recommendation page, and presenting at least one intelligent space template recommended based on a current geographical position on the template recommendation page; in response to a selection operation on the intelligent space template, displaying a template editing page corresponding to a selected intelligent space template, wherein the template editing page is configured to edit the functional regions, the devices, and device control services within the selected intelligent space template; in response to a save operation on an edited intelligent space template, applying the edited intelligent space template to the template space.

It should be noted that the template space refers to the space in which the user wishes to configure device control services. For instance, if the user wants to configure device control services for the entire residence, the residence is regarded as the template space; or, if the user wants to configure device control services for the bedroom only, the bedroom is regarded as the template space.

In a possible implementation, the electronic device recommends the intelligent space template based on the current geographical position. The current position may be the real time position of the terminal or a position selected by the user.

In one embodiment, displaying the template recommendation page includes: recommending at least one configuration dataset based on the current geographical position, so as to display at least one intelligent space template recommended based on the current geographical position based on the configuration dataset, in the template recommendation page. Specifically, recommending at least one configuration dataset based on the current geographical position may include the following steps:
obtaining the geographical position of the template space; requesting recommendations for the template space based on the obtained geographical position to obtain recommended spatial data; obtaining the configuration dataset based on the recommended spatial data, the device data associated with the recommended spatial data, and the scene linkage data.

Regarding obtaining the geographical position of the template space, it may be derived from the global positioning system, IP address, Wi Fi, or mobile network signal of the electronic device under the smart home network, or it may be entered manually by the user; no limitation is imposed herein.

Spatial data indicates the functional regions within the spatial layout diagram of the target space that match the geographical position of the template space; that is, the spatial data may display, in the template recommendation page, the functional regions of the target space in the intelligent space template. It should be noted that the target space refers to the different spaces in homes where smart devices have already been configured with device control services; the target space is stored on the server side so that the server may recommend the intelligent space template.

It should be understood that the greater the similarity between the geographical positions, the higher the probability that the template space and the target space are similar. For example, the template space may be the living room in User A's residence, and the target space may be the living room in User B's residence. If Users A and B share the same geographical position—meaning they live in the same community—the probability that the living rooms in different residences of the same community have identical spatial layouts is higher. Accordingly, the user terminal may recommend corresponding spatial data to the user based on the current geographical position. Specifically, the user terminal sends a recommendation request to the server; the request carries the geographical position of the template space. After the server receives the geographical position from the request, it searches the stored target spaces for those whose geographical positions are similar and treats them as recommended spatial data.

Of course, the template space is not limited to a small independent space within a larger one, such as the living room mentioned earlier; it may also refer to the larger space itself, such as the entire residence—no limitation is imposed here. For example, residences in the same geographical position (e.g., the same community) are likely to share identical floor plan layouts.

The configuration dataset may include spatial data, device data, and scene linkage data configured for the target space. Device data indicates devices that may be deployed in the template space, i.e., device data may display, in the template recommendation page, devices deployable in the template space. Scene linkage data indicates the device control services provided for devices deployable in the template space. In one possible implementation, the configuration dataset may be configured to display, in the template recommendation page, the functional regions, devices, and corresponding device control services in the target space of the intelligent space template.

After determining the functional regions of the target space from the recommended spatial data, the user terminal also simultaneously determines the devices deployable in the template space and the device control services that may be provided for those devices. Therefore, the spatial data, device data, and scene linkage data are recommended to the user as a single configuration dataset.

Device control services may include device services, scene services, and automation services. Through device services, the user may view the device states of each device via the user terminal and control the devices to perform actions. Through scene services, the user may configure multiple scenes, such as a “coming home” scene or a “reading” scene; when a scene is triggered, the devices in the scene perform actions. Through automation services, the user may configure automation instructions; when the trigger conditions of an automation instruction are met, the devices perform actions. The above solutions are provided by way of example only and do not limit the present disclosure.

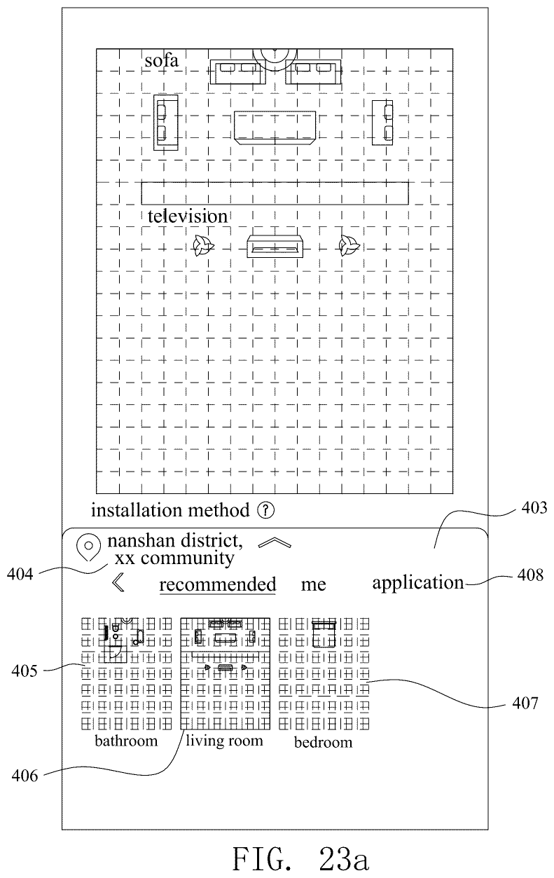

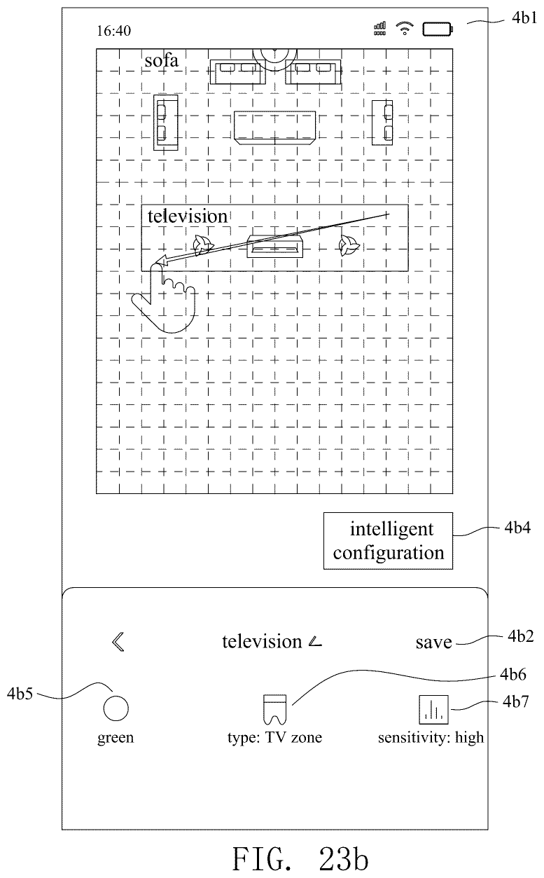

The template recommendation page is configured to display intelligent space templates. For example, FIG. 23a illustrates one template recommendation page. As shown in FIG. 23a, the template recommendation page 401 includes an intelligent space template display area 402 and an editing area 403 corresponding to the currently selected intelligent space template. The intelligent space template display area 402 shows the current geographical position 404—namely, “××Community, Nanshan District”—which is obtained from the real time position of the user terminal or from a position manually selected by the user. The intelligent space template display area 402 also shows thumbnail previews of three recommended intelligent space templates: the “Bathroom” intelligent space template thumbnail 405, the “Living Room” intelligent space template thumbnail 406, and the “Bedroom” intelligent space template thumbnail 407.

Intelligent space template recommendations may be based not only on the current geographical position but also on the functional regions of the template space, on devices deployed in the functional regions of the template space, or on the user's device usage habits—no limitation is imposed.

The selection operation is configured to jump to the template editing page corresponding to the selected intelligent space template so that the template may be edited. If the recommended intelligent space template meets the user's expectations, the user may trigger the control entry corresponding to the selection operation on the intelligent space template to enter the template editing page for that intelligent space template.

For example, referring again to FIG. 23a, the intelligent space template display area 403 additionally shows three recommended intelligent space template thumbnails together with an apply entry 408. If the user taps the apply entry—in other words, elects to apply the currently selected intelligent space template to the template space—the electronic device detects the selection operation at the apply entry and, in response, treats that template as the intelligent space template for the template space. FIG. 23b illustrates the resulting template editing page 4b1 corresponding to the “Living Room” intelligent space template. The template editing page 4b1 presents a region editing area 4b2 and an editing entry area 4b3. The editing entry area 4b3 contains configuration data edit entry 4b4, color entry 4b5, functional tag entry 4b6, and sensitivity entry 4b7. A tap on the apply entry constitutes the selection operation.

It should be noted that the form of the operation triggered at the control entry may differ based on the input component (mouse, touch screen, keyboard) configured on the electronic device. For example, if the electronic device is a smart phone with a touch screen, the operation may be tap, swipe, or other gesture; if it is a desktop computer with a mouse, the operation may be single click, double click, drag, or other mechanical action-no limitation is imposed herein.

Furthermore, selecting an intelligent space template may automatically adapt to devices and/or scenes in the user's smart home network. For instance, the configuration dataset may contain device data and linkage data for a projector, yet the user's network actually lacks a projector. In such cases, the irrelevant parts of the configuration data are ignored when the template is applied; alternatively, the user may manually adapt the configuration data to actual conditions-no limitation is imposed.

In one possible implementation, editing the configuration data involves the following steps: displaying the editable configuration data on the template editing page.

As previously stated, the configuration data includes spatial data, device data, and scene linkage data. The user may edit the three kinds of configuration data as needed so that the edited data meets personal requirements.

If an edit operation on the editable configuration data is detected, the intelligent space template on the template editing page is updated based on the edited configuration data.

The edit operation is configured to modify the editable configuration data displayed on the template editing page. A control entry for triggering the edit operation is placed on the template editing page. When the user wishes to edit the configuration data, the edit operation is triggered at that control entry.

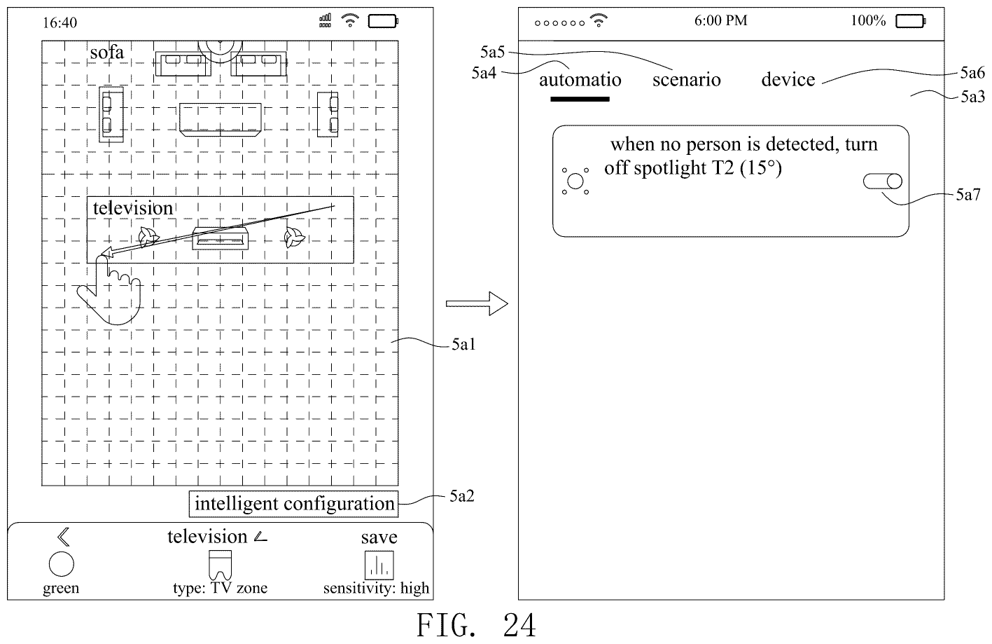

For example, FIG. 24 shows an example of editing configuration data. template editing page 5a1 displays control entry 5a2. A tap on 5a2 causes the electronic device to detect an edit operation on the editable configuration data and, in response, jump to configuration data page 5a3. Page 5a3 shows edit entries 5a4 for device data, edit entry 5a5 for scene linkage data, and another edit entry 5a6 for scene linkage data. Tapping 5a6 displays the automation instruction list (see 5a7), enabling the instruction “When no person is detected, turn off spotlight T2 (15°)”. A tap constitutes the edit operation.

Optionally, when the user connects any device to the IoT via the user terminal, the intelligent space template may look up data matching that device based on the configuration dataset and present the corresponding device control service. For instance, if the template contains the automation instruction “Turn off light when no one is present” and the user connects spotlight T2 to the IoT, the server detects T2 and matches it to the instruction. FIG. 24 then shows, on configuration data page 5a3, the automation instruction “Turn off spotlight T2 (15°) when no one is detected”.

It should be added that, because an intelligent space template may not perfectly match the user's actual home, e.g., a “Living Room” template shows a “Dining table” functional region whereas the user's “tea table” actually occupies that space, the functional region may be adjusted so that the template conforms to reality.

In one possible implementation, after displaying the template recommendation page, the method may further include:
in response to a region edit operation on a functional region displayed on the template recommendation page, displaying a region edit entry corresponding to the functional region on the template recommendation page; the region edit entry including at least one of a functional tag entry and a sensitivity entry; when a color edit operation on the color entry is detected, displaying the functional region in the configuration page based on the edited color; when a tag edit operation on the functional tag entry is detected, displaying the functional region in the configuration page based on the edited functional tag. when a sensitivity edit operation on the sensitivity entry is detected, adjusting the region monitoring sensitivity of the functional region.

The region edit operation edits the functional region; its control entry may be located in the intelligent space template. When the user wishes to edit a functional region, the control entry is triggered.

The region edit entry provides specific edit items and may include at least one of a color entry, a functional tag entry, and a sensitivity entry. The color entry corresponds to the color edit operation. The functional tag entry corresponds to the tag edit operation. The sensitivity entry corresponds to the sensitivity edit operation.

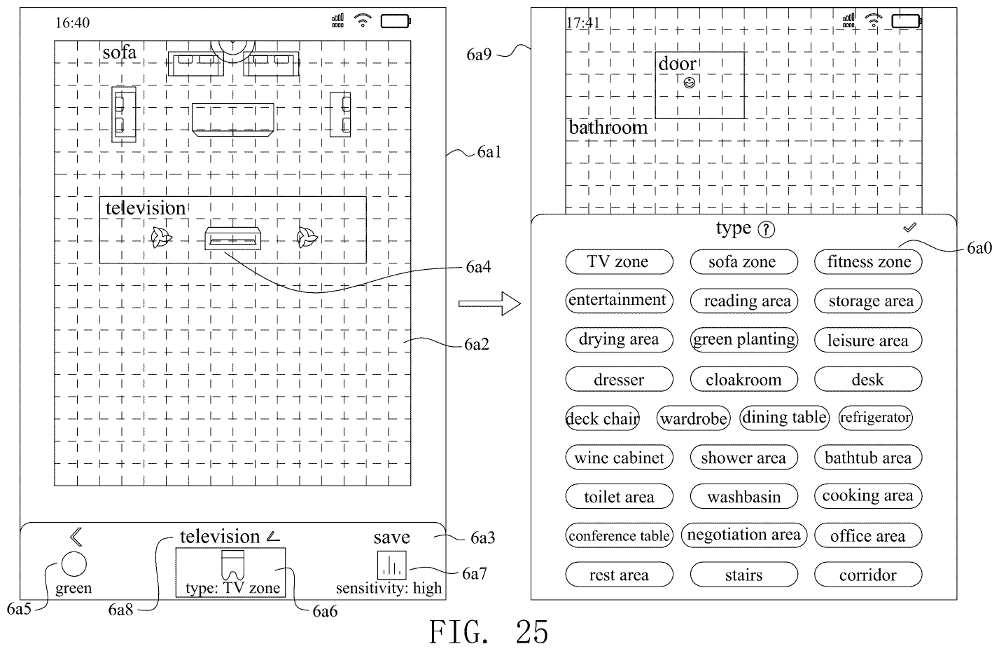

For example, FIG. 25 illustrates a region edit operation. template editing page 6a1 shows region editing area 6a2 and edit entry area 6a3. Area 6a2 displays the functional regions in the intelligent space template; area 6a3 shows the edit entries for each region. When the user taps the “TV” functional region 6a4 in 6a2, 6a3 displays color entry 6a5, functional tag entry 6a6, sensitivity entry 6a7, and name entry 6a8 for the “TV zone”.

Each functional region in the smart template page may have a distinct background color; displaying regions in different colors helps the user distinguish them. The color edit operation changes the background color of a functional region. To change the color, the user triggers the color entry. For example, referring again to FIG. 25, color entry 6a5 for the “TV zone” is shown in 6a2. A tap on 6a5 causes the electronic device to detect the color edit operation and, in response, display a color selection page offering several optional background colors. Choosing one color applies it as the background of the “TV zone”. The tap constitutes the color edit operation.

The function of a region is not immutable. If the device in a region changes, the region type may change accordingly. The functional tag indicates the region's purpose. For instance, if a “TV” region's television is replaced by a tea table, the functional tag may be changed from “TV” to “Tea Table”.

The tag edit operation changes the type of the functional region. To edit the region type, the user triggers the functional tag entry.

For example, in FIG. 25, tapping functional tag entry 6a6 for the “TV zone” causes the electronic device to detect the tag edit operation and display functional tag selection page 6a9, offering tags such as TV zone, sofa zone, fitness zone, etc. Selecting “Fitness Zone” 6a0 converts the “TV zone” into the “Fitness Zone”. The tap is the tag edit operation.

The sensitivity edit operation adjusts the region monitoring sensitivity of a functional region. Region monitoring sensitivity indicates the minimum signal strength that the corresponding device may detect in the region; higher sensitivity allows more accurate detection of weaker signals. For example, if the device is a human presence sensor and the region monitoring sensitivity is set to high, the sensor may detect even slight human presence in the region. To adjust sensitivity, the user triggers the sensitivity entry.

For example, in FIG. 25, tapping sensitivity entry 6a4 for the “TV zone” causes the electronic device to detect the sensitivity edit operation and raise the region monitoring sensitivity from low to high. The tap constitutes the sensitivity edit operation.

In one possible implementation, if the user selects the functional tag of a region, the server pushes the corresponding region monitoring sensitivity to the user terminal based on a pre-stored “functional tag-region monitoring sensitivity” mapping table, and the sensitivity is displayed at the sensitivity entry in the region edit area. The user may still adjust the sensitivity by triggering the sensitivity entry.

Optionally, if an intelligent space template lacks a functional region, the corresponding functional region may be added.

In one possible implementation, after displaying the template recommendation page, the method may further include: in response to a region add operation triggered in any blank display area of the template recommendation page, displaying an added functional region in the blank display area of the template recommendation page; obtaining a configuration operation on the added functional region and displaying a region configuration page corresponding to the functional region; in response to configuration data configured in the region configuration page, generating device control service for the functional region.

The template recommendation page may include a region editing page. Users may also select any arbitrary region on the region editing page of the user terminal to create a custom functional region. Specifically, the user may add a new custom functional region in a blank area of the region editing page or create a new custom functional region on the basis of an existing one; the newly created functional region may overlap the existing one.

The user may further perform a configuration operation on the added functional region. Specifically, on the region configuration page or the automation configuration page, the user may select the added functional region to display its corresponding configuration page. On this page, the user may configure items related to the device control service, such as trigger conditions and target actions. Based on the configuration data set on the region configuration page, a device control service for the functional region is generated, enabling the user to configure appropriate service functions for the custom region.

The save operation saves the edited intelligent space template so that it may be applied to the template space for subsequent use in smart home services.

Through the above process, the configuration data recommended based on the current geographical position not only presents the user with functional regions in the template space that match the geographical position of the template space, but also recommends devices deployable in those functional regions and the device control services provided for those devices. This spares the user from manually configuring each smart device in every household space one by one, effectively reducing the complexity of configuring device control services for smart devices in different household spaces and improving the user's smart home experience. In addition, by providing an editing function for the recommended intelligent space templates, the user may, based on personal needs, customize the functional regions, devices, and device control services within an intelligent space template, making the edited template more practical and better aligned with user requirements, thereby further enhancing the smart home experience.

Of course, even when the template space matches the geographical position, differences may still exist in spatial layout or other aspects under the same geographical position—for example, different functional regions, different deployed devices, or different device control services provided for the devices. To ensure that the recommended intelligent space templates better suit the user's actual situation, recommendations may also be based on functional regions within the template space, on devices deployed in the template space, or on device usage habits in the template space.

In an exemplary embodiment, displaying the template recommendation page may further include: recommending at least one configuration dataset, based on the functional region of the template space, so as to display the functional region of the template space, as well as at least one intelligent space template recommended based on the configuration dataset, on the template recommendation page. Specifically, the following steps may be included:
obtaining a functional tag of the functional region of the template space; based on the functional tag, searching a first candidate space within the target space, and a functional region of the first candidate is similar to the functional region of the template space; acting spatial data of the first candidate space, together with the device data and the scene linkage data associated with the spatial data of the first candidate space, as the configuration dataset.

As previously described, functional regions indicate the purposes of regions within the template space. Optionally, the template space may include several functional regions, from which several functional tags are obtained.

It may be understood that the greater the similarity between the functional regions of the target space and the functional regions of the template space, the better the match between the target space and the template space. For example, the template space includes a sofa area, a TV area, and a coffee table area; Target Space A includes a sofa area and a projector area, while Target Space B includes a sofa area and a TV area; therefore, the template space matches Target Space B better.

It should be added that determining similarity between the template space and the target space may be achieved when the similarity satisfies a similarity threshold—for example, if the similarity between the functional regions of the template space and those of the target space exceeds 80%, the two are deemed similar; or when the number of identical functional regions exceeds a set value—for example, if the two share more than three identical functional regions, they are deemed similar. The above examples are illustrative only and do not limit the present disclosure.

Thus, after identifying the first candidate space whose functional regions are similar to those of the template space, corresponding spatial data may be obtained based on the first candidate space. After the user terminal obtains the spatial data and determines the functional regions of the first candidate space, it simultaneously determines the devices deployable in the functional regions of the first candidate space and the device control services that may be provided for those devices. Consequently, the spatial data, device data, and scene linkage data are treated as the configuration dataset and configured to recommend the corresponding intelligent space template to the user, so that the user receives an intelligent space template whose functional regions are more similar to those of the template space. Moreover, when different users furnish the same template space, they may configure different devices based on actual needs; therefore, corresponding target spaces may be recommended based on the devices already configured in the template space.

In an exemplary embodiment, displaying the template recommendation page may include: recommending at least one configuration dataset based on a device deployed in the template space, so as to display the device deployed in the template space, as well as at least one intelligent space template recommended based on the configuration dataset, on the template recommendation page. Specifically, recommending at least one configuration dataset based on the device deployed in the template space may include the following steps:
obtaining target device data of the template space; based on the target device data, searching the target space for a second candidate space whose deployed device is similar to the device already deployed in the template space; acting the spatial data of the second candidate space, the device data associated with the spatial data of the second candidate space, and the scene linkage data as the configuration dataset.

The target device data indicates a device already deployed in the template space.

It may be understood that the greater the similarity between the devices already deployed in the target space and those already deployed in the functional regions of the template space, the better the match between the target space and the template space. For example, the template space includes a desk lamp, a TV, and an air conditioner; Target Space A includes a refrigerator, an air conditioner, and an energy saving lamp, while Target Space B includes an energy saving lamp, a TV, and an air conditioner—hence, the template space matches Target Space B better.

It is further noted that determining whether devices are identical may be based on device type—for example, both energy saving lamps and desk lamps belong to the lamp category—or on device model; for instance, if the models differ, the devices are not considered identical.

Determining similarity between the template space and the target space may be achieved when the similarity exceeds a similarity threshold—for example, if the similarity of deployed devices between the template space and the target space exceeds 80%, the two are deemed similar; or when the number of identical devices exceeds a set value—for example, if more than three devices are identical, they are deemed similar. The above examples are illustrative only and do not limit the present disclosure.

Thus, after the user terminal identifies the second candidate space whose deployed devices are similar to those in the template space, corresponding spatial data may be obtained based on the second candidate space.

After the user terminal obtains the spatial data and determines the functional regions of the second candidate space, it simultaneously determines the devices deployable in the functional regions of the second candidate space and the device control services that may be provided for those devices. Consequently, the spatial data, device data, and scene linkage data are treated as the configuration dataset and configured to recommend the corresponding intelligent space template to the user, so that the user receives an intelligent space template whose deployed devices are more similar to those in the template space.

In addition, device usage habits differ greatly among users. Therefore, in an exemplary embodiment, displaying the template recommendation page, may further include: recommending at least one configuration dataset based on a device usage habit in the template space, so as to display the device usage habit in the template space, as well as at least one intelligent space template recommended based on the configuration dataset, on the template recommendation page. Specifically, recommending at least one configuration dataset based on the device usage habits in the template space may include the following steps:
obtaining device usage data for the template space; the device usage data describing the device usage habit of a user in the template space; based on the device usage data, searching the target space for a third candidate space whose device usage habit is similar to the device usage habits in the template space; acting the spatial data of the third candidate space, the device data associated with the spatial data of the third candidate space, and the scene linkage data as the configuration dataset.

The device usage data describes the user's device usage habits in the template space. Device usage data may indicate device operating times, operating modes, etc. By analyzing device usage data, information such as when and where the user frequently uses which device and in what operating mode may be derived, thereby obtaining the user's device usage habits for functional regions within the template space.

Because different users have inconsistent living habits, their day to day device usage habits also differ. Therefore, by analyzing the device usage data generated in each functional region of the template space for every household, a target space that matches the user's usage habits may be recommended. For example, based on device usage data the system learns that a user appears in the reading area every evening at 8 p.m. to read and turns on the reading light; consequently, when making recommendations, the intelligent space template that turns on the reading light at 8 p.m. is ranked higher.

Accordingly, after the user terminal has located a target space whose device usage habits are similar to the user's, the third candidate space is obtained, and the corresponding spatial data may be derived from the third candidate space.

After the user terminal has obtained the spatial data and determined the functional regions of the third candidate space, it simultaneously determines the devices deployable in the functional regions of the third candidate space and the device control services that may be provided for those devices. Thus, the spatial data, device data, and scene linkage data are taken as the configuration data, and the corresponding intelligent space template is recommended to the user so that the user receives an intelligent space template that better aligns with his or her own device usage habits.

With the cooperation of the above embodiments, intelligent space templates may be recommended not only based on the functional regions within the template space, but also based on the devices deployed in the template space, and further based on the user's device usage habits. On the one hand, this makes the recommended intelligent space templates more consistent with the user's usage scenes, reduces the amount of editing the user may perform on the templates, and lessens the steps and difficulty of setup, thereby solving the problems of cumbersome setup steps and high difficulty. On the other hand, by recommending similar intelligent space templates, users may learn more smart home installation and implementation options, facilitating subsequent custom modifications.

Of course, in other embodiments, intelligent space templates may also be recommended based on any combination of the current geographical position, the functional regions within the template space, the devices deployed in the template space, and the user's device usage habits—for example, recommending templates based on both the current geographical position and the user's device usage habits. The foregoing embodiments do not impose any specific limitation in this regard.

In one embodiment, an application scene may include the following steps, where the scene is a smart home context.

The user opens the template recommendation page.

Obtaining the current geographical position.

Displaying intelligent space templates on the template recommendation page, with templates whose geographical position matches the current position recommended first.

The user selects an intelligent space template and enters the corresponding template editing page.

The user edits the functional regions, devices, and device control services in the intelligent space template on the template editing page and saves the edited template.

Displaying the edited intelligent space template so that it may be applied to the template space.

The user controls the devices in the template space based on the intelligent space template.

Acquiring device usage data.

Analyzing the device usage data periodically to obtain the user's device usage habits.

Recommending intelligent space templates to the user based on the user's device usage habits.

After the user has applied the intelligent space template, the electronic device collects the corresponding device usage data. By comparing the data at set cycles (daily, weekly, monthly), the device usage patterns of the user on a daily, weekly, and monthly basis are obtained, and intelligent space templates that match these patterns are recommended.

In this application scene: First, recommending intelligent space templates via the current geographical position avoids unsupported templates in advance, yields higher matching accuracy, and allows the user to apply the edited template quickly without further editing. Second, recommending intelligent space templates similar to the user's device usage habits enables rapid application, reduces configuration operations, and enhances the smart home experience.

It should be understood that, although the steps in flowcharts such as FIG. 2 and FIG. 14 are shown sequentially based on arrow directions, these steps are not necessarily performed in the order indicated by the arrows. Unless explicitly stated otherwise, there is no strict sequential limitation on the execution of these steps, and they may be performed in other orders. Moreover, at least some of the steps in FIG. 2 and FIG. 14 may include multiple sub steps or multiple stages that need not be completed at the same moment; they may be executed at different times, and their execution order need not be sequential—they may be performed in rotation or alternation with at least part of other steps or sub steps/stages of other steps.

The following describes an apparatus embodiment of the present application, which may be configured to execute the spatial configuration method involved in the present application. For details not disclosed in the apparatus embodiment, please refer to the embodiments of the spatial configuration method involved in the present application.

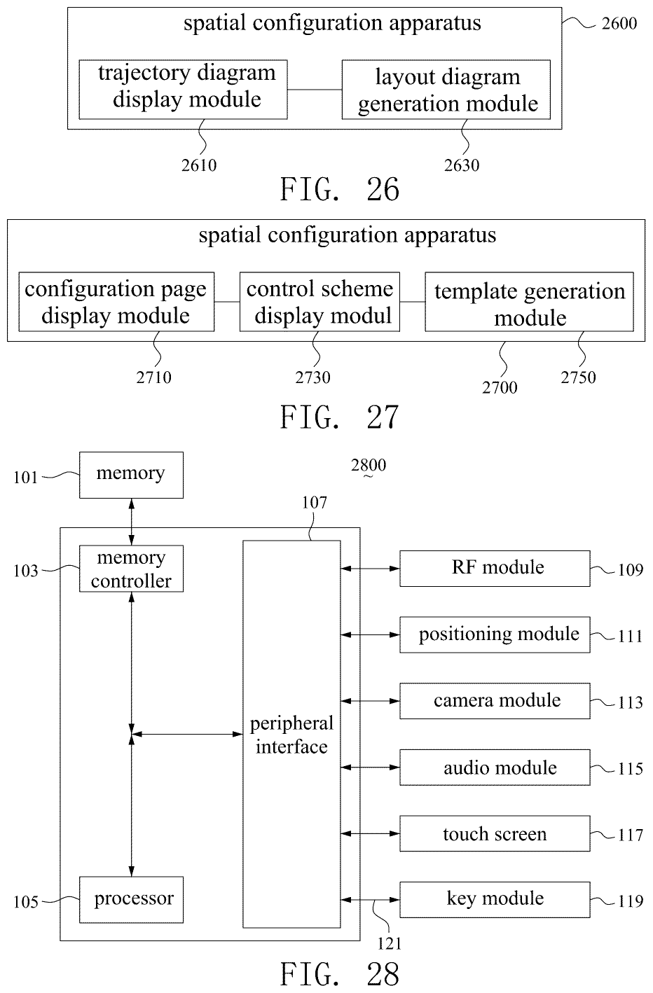

Refer to FIG. 26. The present application provides, in an embodiment, a spatial configuration apparatus 2600, which includes, without limitation, a trajectory diagram display module 2610 and a layout diagram generation module 2630. The trajectory diagram display module 2610 is configured to obtain trajectory information of a first target object within each space of a target space, draw a trajectory diagram for each space based on the trajectory information, and display the trajectory diagram; the trajectory information indicates movement trajectories of the first target object in each space. The layout diagram generation module 2630 is configured to mark an entrance and exit position of each space on the trajectory diagram of each space and to match the marked entrance and exit positions with the trajectory diagrams of each space to obtain a spatial layout diagram corresponding to the target space.

In one embodiment, the layout diagram generation module 2630 includes a first entrance and exit position marking unit. The first entrance and exit position marking unit is configured to mark the entrance and exit position of each space on the trajectory diagram of each space based on the trajectory information of the first target object within each space. The trajectory information is obtained by tracking a trajectory of the first target object based on echo signals, the echo signals are reflections of a radar device's transmitted signals from the first target object.

In one embodiment, the layout diagram generation module 2630 includes a second entrance and exit position marking unit. The second entrance and exit position marking unit is configured to, in response to a spatial open-close event triggered in each space, determine positions of the first target object in each space at a time when the spatial open-close event is triggered, and mark the entrance and exit position of each space at corresponding regions on the trajectory diagram of each space based on the determined positions.

In one embodiment, the layout diagram generation module 2630 includes a third entrance and exit position marking unit. The third entrance and exit position marking unit is configured to, in response to a marking operation on a access location, identify two adjacent spaces associated with the access location, and mark the access location on trajectory diagrams of the two adjacent spaces as the entrance and exit position of the two adjacent spaces. The access location indicates a position at which the first target object passes when entering or exiting between the two adjacent spaces.

In one embodiment, the spatial configuration apparatus 2600 may further include an environmental model display module. The environmental model display module is configured to display an environmental model corresponding to the target space, and when a change in at least one state among the states of the first target objects and the second target objects is recognized, display at least one of an updated first target object and an updated second target object in the environmental model. The environmental model includes at least one state among the states of the first target objects and the second target objects in the target space. The environmental model is generated based on the spatial layout diagram of the target space and positions of the second target objects in the target space. The spatial layout diagram is generated based on a relationship between the trajectory of the first target object in the target space and each space in the target space.

In one embodiment, the spatial configuration apparatus 2600 may further include: a layout diagram display module, an identification module and an environmental model generation module. The layout diagram display module is configured to display the spatial layout diagram corresponding to the target space. The identification module is configured to identify each second target object deployed in the target space and obtain positions of the identified second target objects in the target space. The environmental model generation module is configured to generate an environmental model of the target space based on the positions of the second target objects in the target space and the spatial layout diagram. The environmental model describes at least one state among the states of the first target object and the second target objects in the target space.

In one embodiment, the environmental model generation module includes a first region determination unit and an environmental model generation unit. The first region determination unit is configured to determine a corresponding region in the spatial layout diagram for each second target object based on the position of each second target object in the target space. The environmental model generation unit is configured to display an object marker for each second target object in the corresponding region of the spatial layout diagram to generate the environmental model. The object marker for each second target object indicates the state of the second target object.

In one embodiment, the spatial configuration apparatus 2600 further includes an environmental model update module. The environmental model update module is configured to, identify a newly deployed second target object in the target space, display an object marker of the newly deployed second target object in a corresponding region of the spatial layout diagram, and update the environmental model, based on an association relationship between each already displayed second target object and signal features of echo signals. The echo signals are obtained by a radar device capturing micro doppler signals generated while the second target object is operating.

In one embodiment, the second target object includes an electronically controlled object. The electronically controlled object is a device that produces micro doppler signals while operating. The identification module includes a second region determination unit and state identification unit. The second region determination unit is configured to locate a position of the electronically controlled object based on echo signals and identify a position of the electronically controlled object in the target space to determine a corresponding region for the electronically controlled object in the spatial layout diagram. The state identification unit is configured to identify a state of the electronically controlled object as an ON state to mark the electronically controlled object that is in the ON state within the corresponding region determined in the spatial layout diagram, based on the radar device's capture of the micro-doppler signals generated while the electronically controlled object is operating. The echo signals are micro-doppler signals captured by the radar device while the electronically controlled object is operating.

In one embodiment, the second target object includes a non electronically controlled object. The non electronically controlled object is a facility incapable of generating micro-doppler signals. The identification module includes a position identification unit and a third region determination unit. The position identification unit is configured to locate a position of the first target object interacting with the non electronically controlled object based on echo signals to obtain the position of the first target object within the target space. The third region determination unit is configured to identify a position of the non electronically controlled object within the target space based on the position of the first target object within the target space to determine a corresponding region of the non electronically controlled object within the spatial layout diagram. The echo signals are obtained by reflection of a radar device's transmitted signal off the first target object.

In one embodiment, the second target object includes a smart device. The identification module includes: a fourth region determination unit and a type identification unit. The fourth region determination unit is configured to determine a region range of the smart device within the target space, when detecting that a state of the smart device has changed from an OFF state to an ON state. The type identification unit is configured to, within the determined region range, when the radar device captures micro-doppler signals generated while the second target object is operating, identify a device type of the smart device as an object type of the second target object so as to mark the second target object based on the device type of the smart device within the spatial layout diagram.

In one embodiment, the trajectory diagram includes an edge region. The trajectory diagram display module 2610 includes a region configuration page display, a prompt information generation unit, a trajectory information acquisition unit, an edge region display unit and a trajectory diagram display unit. The region configuration page display unit is configured to display a region configuration page for the target space, the region configuration page includes an edge configuration item. The prompt information generation unit is configured to, in response to a trigger operation on the edge configuration item, generate prompt information, the prompt information indicates the first target object to move within each space of the target space. The trajectory information acquisition unit is configured to obtain trajectory information of the first target object within each space of the target space. The trajectory information is derived from detection information obtained while the first target object moves within the spaces. The edge region display unit is configured to display an automatically generated edge region on the region configuration page, the edge region is determined from the detection information corresponding to movements of the first target object in the target space. The trajectory diagram display unit is configured to draw and display a trajectory diagram for each space based on the trajectory information and the edge region.

In one embodiment, the spatial configuration apparatus 2600 further includes a first page display module configured to, in response to an adjustment operation on the edge region, display a target edge region adjusted on the region configuration page, and in response to a trigger operation on a save item in the region configuration page, synchronize the target edge region to a detection device that provides the detection information.

In one embodiment, the spatial configuration apparatus 2600 further includes a second page display module configured to obtain a trigger operation on a currently selected region in the region configuration page, display a property configuration page for the currently selected region, the property configuration page including a region adjustment item, and in response to a trigger operation on the region adjustment item, display a property selection page corresponding to the region adjustment item, and obtain property configuration information selected in the property selection page to apply the property configuration information to the currently selected region.

In one embodiment, the spatial configuration apparatus 2600 further includes a third page display module. The third page display module is configured to obtain any region selected in the spatial region on the region configuration page to generate a customized monitoring region, the spatial region is a region corresponding to the target space on the region configuration page; in response to a selection operation on the monitoring region, display a function configuration page for the selected monitoring region, obtain control attribute information configured in the function configuration page, and generate an automatic control scheme for each monitoring region; the configured monitoring region and the edge region are configured to implement automatic control via region based detection.

In one embodiment, the spatial configuration apparatus 2600 further includes a detection information acquisition module, a position determination module and an edge region determination module. The detection information acquisition module is configured to obtain detection information collected by a detection device based on a detection instruction while the first target object moves in the target space, the detection instruction is generated in response to a trigger operation on the edge configuration item in the region configuration page. The position determination module configured to determine, based on the detection information, a position of the first target object in the target space and a position of a ghost target corresponding to the first target object. The edge region determination module configured to determine an edge region corresponding to the target space based on the position of the first target object and the position of the ghost target, the obtained edge region is configured to automatically display, in response to a trigger operation on the edge configuration item, in the region configuration page.

In one embodiment, the position determination module includes a target identification unit, a distance determination unit, and a position determination unit. The target identification unit is configured to identify positions of targets in the target space based on the detection information. The targets include the first target object and the ghost target. The distance determination unit is configured to determine distances between the targets and the detection device based on the positions of the targets. The position determination unit is configured to determine the first target object in the target space and the ghost target corresponding to the first target object based on the distances between the targets and the detection device, thereby obtain the position of the first target object and the position of the ghost target.

In one embodiment, the position determination unit includes a first target object determination sub unit, and a ghost target determination sub unit. The first target object determination sub unit is configured to determine, as the first target object, the target whose distance to the detection device is the smallest among all targets. The ghost target determination sub unit is configured to determine, as the ghost target corresponding to the first target object, all targets other than the first target object.

Refer to FIG. 27. The present application further provides, in an embodiment, a spatial configuration apparatus 2700, which includes: a configuration page display module 2710, a control scheme display module 2730, and a template generation module 2750. The configuration page display module 2710 is configured to display a spatial configuration page; the spatial configuration page includes a spatial region; the spatial region includes a region taken from a spatial layout diagram corresponding to a target space, wherein the spatial layout diagram is obtained from trajectory information of a first target object within each space of the target space and entrance and exit positions of each space; the spatial layout diagram also displays previously added second target objects at corresponding positions. The control scheme display module 2730 is configured to display, in a scheme presentation area of the spatial configuration page, a generated device control scheme; the device control scheme is generated by matching relationships among second target objects under the target space. The template generation module 2750 is configured to, in response to a save operation on a selected device control scheme, generate an intelligent space template based on the device control schemes; the intelligent space template is configured for match application to spaces compatible with the target space.

It should be noted that, when the spatial configuration apparatus 2700 provided in the above embodiments performs spatial configuration, only the division of the above functional modules is used as an example. In actual applications, the above functions may be allocated to different functional modules based on needs; that is, the internal structure of the spatial configuration apparatus 2700 may be divided into different functional modules to perform all or part of the functions described above.

In addition, the spatial configuration apparatus 2700 provided in the above embodiments and the embodiments of the spatial configuration method belong to the same inventive concept. The specific operation manner of each module has been described in detail in the method embodiments and will not be repeated here.

Refer to FIG. 28. FIG. 28 is a schematic structural diagram of an electronic device based on an exemplary embodiment. The electronic device is applicable to the user terminal 110 shown in the implementation environment of FIG. 1.

It should be noted that the electronic device is only an example adapted to the present application and should not be regarded as providing any limitation on the scope of use of the present application. The electronic device should also not be interpreted as requiring reliance on or necessarily having one or more components shown in the exemplary electronic device 2800 in FIG. 28.

As shown in FIG. 28, the electronic device 2800 includes a memory 101, a memory controller 103, one or more (only one shown in FIG. 28) processors 105, a peripheral interface 107, an RF module 109, a positioning module 111, a camera module 144, an audio module 146, a touch screen 117, and a key module 119. These components communicate with each other via one or more communication buses/signal lines.

The memory 101 may be configured to store computer programs and modules, such as the computer programs and modules corresponding to the spatial configuration method and apparatus in the exemplary embodiments of the present application. The processor 105 executes the computer programs stored in the memory 101 to perform various functions and data processing, that is, to complete the spatial configuration method.

As a resource storage carrier, the memory 101 may be random access memory, such as high speed random access memory, or non volatile memory, such as one or more magnetic storage devices, flash memories, or other solid state memories. The storage may be temporary or permanent.

The peripheral interface 107 may include at least one wired or wireless network interface, at least one serial/parallel conversion interface, at least one input/output interface, and at least one USB interface, etc., for coupling various external input/output devices to the memory 101 and the processor 105 to achieve communication with various external input/output devices.

The RF module 109 is configured to receive and transmit electromagnetic waves to realize mutual conversion between electromagnetic waves and electrical signals, thereby communicating with other devices via a communication network. The communication network includes cellular telephone networks, wireless local area networks, or metropolitan area networks, and the above communication networks may use various communication standards, protocols, and technologies.

The positioning module 111 is configured to obtain the current geographical position where the electronic device 2800 is located. Examples of the positioning module 111 include, but are not limited to, the Global Positioning System (GPS) and positioning technologies based on wireless local area networks or mobile communication networks.

The camera module 113 belongs to a camera and is configured to capture images or videos. The captured images or videos may be stored in the memory 101 or sent to a host computer via the RF module 109.

The audio module 115 provides an audio interface to the user, which may include one or more microphone interfaces, one or more speaker interfaces, and one or more headphone interfaces. Audio data is exchanged with other devices through the audio interface. Audio data may be stored in the memory 101 or sent via the RF module 109.

The touch screen 117 provides an input/output interface between the electronic device 1100 and the user. Specifically, the user may perform input operations through the touch screen 117, such as clicking, touching, sliding, or other gesture operations, so that the electronic device 2800 responds to the input operation. The electronic device 2800 displays output content in the form of text, images, or video, or any combination thereof, to the user via the touch screen 117.

The key module 119 includes at least one key to provide an interface for the user to input to the electronic device 2800. The user may press different keys to cause the electronic device 2800 to perform different functions. For example, a volume adjustment key allows the user to adjust the volume of audio played by the electronic device 2800.

It may be understood that the structure shown in FIG. 28 is only schematic. The electronic device 2800 may also include more or fewer components than those shown in FIG. 28, or have components different from those shown in FIG. 28. The components shown in FIG. 28 may be implemented by hardware, software, or a combination thereof.

In addition, the present application provides, in an embodiment, a computer readable storage medium storing computer readable instructions, which, when executed by a processor, implement the spatial configuration method in the above described embodiments.

The present application provides, in an embodiment, a computer readable instruction product, the computer readable instruction product including computer readable instructions stored in a computer readable storage medium. A processor of a computer device reads the computer readable instructions from the computer readable storage medium, and the processor executes the computer readable instructions so that the computer device performs the spatial configuration method in the above described embodiments.

It should be understood that, although the steps in the flowcharts in the accompanying drawings are shown sequentially based on the direction of the arrows, these steps are not necessarily executed in the order indicated by the arrows. Unless explicitly stated otherwise, there is no strict sequential limitation on the execution of these steps, and they may be executed in other orders. Moreover, at least some of the steps in the flowcharts in the accompanying drawings may include multiple sub steps or multiple stages, which need not be completed at the same moment, but may be executed at different moments, and their execution order need not be sequential, but may be executed in rotation or alternation with at least part of other steps or sub steps/stages of other steps.

The above descriptions are only part of the embodiments of the present application. It should be noted that, for those of ordinary skill in the art, without departing from the principles of the present application, several improvements and modifications may be made, and these improvements and modifications should also be regarded as within the protection scope of the present application.

What is claimed is:

1. A spatial configuration method, executed by an electronic device, the method comprising:
obtaining trajectory information of a first target object within each space of a target space, generating and displaying a trajectory diagram for each space based on the trajectory information, the trajectory information indicating movement trajectories of the first target object in each space;
marking an entrance and exit position of each space on the trajectory diagram of each space, and matching marked entrance and exit positions with the trajectory diagram of each space to obtain a spatial layout diagram corresponding to the target space.

2. The method of claim 1, wherein marking the entrance and exit position of each space on the trajectory diagram of each space comprises at least one of:
based on the trajectory information of the first target object within each space, marking the entrance and exit position of each space on the trajectory diagram of each space; wherein the trajectory information is obtained by tracking a trajectory of the first target object based on echo signals, transmitted by a radar device from the first target object;
in response to a spatial open-close event triggered in each space, determining positions of the first target object in each space at a time when the spatial open-close event is triggered, and marking the entrance and exit position of each space at corresponding regions on the trajectory diagram of each space based on determined positions;
in response to a marking operation on a access location, identifying two adjacent spaces associated with the access location, and marking the access location on trajectory diagrams of the two adjacent spaces as the entrance and exit position of the two adjacent spaces; wherein the access location indicates a position at which the first target object passes when entering or exiting between the two adjacent spaces.

3. The method of claim 1, wherein the method further comprises:
displaying an environmental model corresponding to the target space; the environmental model comprising at least one state first target objects and second target objects in the target space; the environmental model generated based on the spatial layout diagram of the target space and positions of the second target objects in the target space; the spatial layout diagram generated based on a relationship between the trajectory of the first target object in the target space and each space in the target space;
when a change in at least one state of the first target objects and the second target objects is recognized, displaying at least one of an updated first target object and an updated second target object in the environmental model.

4. The method of claim 1, wherein the method further comprises:
displaying the spatial layout diagram corresponding to the target space;
identifying second target objects deployed in the target space and determining positions of the second target objects in the target space;
generating an environmental model of the target space based on the position of each second target object in the target space and the spatial layout diagram; wherein the environmental model of the target space describes at least one state of states of the first target object and each second target object in the target space.

5. The method of claim 4, wherein said generating the environmental model of the target space based on the position of each second target object in the target space and the spatial layout diagram, comprises:
determining a corresponding region in the spatial layout diagram for each second target object, based on the position of each second target object in the target space;
displaying an object marker for each second target object in the corresponding region of the spatial layout diagram, to generate the environmental model; wherein the object marker for each second target object is configured to indicate the state of the second target object;
after displaying the object marker for each second target object in the corresponding region of the spatial layout diagram, to generate the environmental model, the method further comprises: based on an association relationship between each of displayed second target objects and signal features of echo signals, identifying a newly deployed second target object in the target space; the echo signals are obtained by a radar device capturing micro-doppler signals generated while the second target object is operating;
displaying an object marker of the newly deployed second target object in a corresponding region of the spatial layout diagram so as to update the environmental model.

6. The method of claim 4, wherein the second target object comprises an electronically controlled object; the electronically controlled object is a device that produces micro-doppler signals while operating;
identifying each second target object deployed in the target space comprises at least one of:
locating a position of the electronically controlled object based on echo signals and identifying a position of the electronically controlled object in the target space, to determine a corresponding region for the electronically controlled object in the spatial layout diagram; wherein the echo signals are obtained by a radar device capturing micro-doppler signals generated while the electronically controlled object is operating;
based on capture of the radar device of the micro-doppler signals generated while the electronically controlled object is operating, identifying a state of the electronically controlled object as an ON state, so as to mark the electronically controlled object that is in the ON state within the corresponding region determined in the spatial layout diagram.

7. The method of claim 4, wherein the second target object comprises a non electronically controlled object; the non electronically controlled object is a facility incapable of generating micro-doppler signals;
identifying each second target object deployed in the target space comprises:
locating a position of the first target object interacting with the non electronically controlled object based on echo signals, to obtain the position of the first target object within the target space; wherein the echo signals are generated by a reflection of a transmission signal from a radar device from the first target object;
identifying a position of the non electronically controlled object within the target space, based on the position of the first target object within the target space, so as to determine a corresponding region of the non electronically controlled object within the spatial layout diagram.

8. The method of claim 4, wherein the second target object comprises a smart device; identifying each second target object deployed in the target space comprises:
when detecting that state of the smart device has changed from an OFF state to an ON state, determining a region range of the smart device within the target space;
within the determined operational region, in response to the radar device capturing micro-Doppler signals generated by the smart device during operation, identifying a device type of the smart device as an object type of the second target object, so as to mark the second target object based on the device type of the smart device within the spatial layout diagram.

9. The method of claim 1, the trajectory diagram comprising an edge region, wherein said obtaining the trajectory information of the first target object within each space of the target space, generating and displaying the trajectory diagram for each space based on the trajectory information, comprises:
displaying a region configuration page for the target space, the region configuration page comprising an edge configuration item;
in response to a trigger operation on the edge configuration item, generating prompt information, wherein the prompt information indicates the first target object to move within each space of the target space;
obtaining the trajectory information of the first target object within each space of the target space, wherein the trajectory information is derived from detection information obtained while the first target object moves within the spaces;
displaying the edge region on the region configuration page, wherein the edge region is determined from the detection information corresponding to movements of the first target object in the target space;
generating and displaying the trajectory diagram for each space based on the trajectory information and the edge region.

10. The method of claim 9, wherein after displaying the region configuration page for the target space, the method further comprises at least one of:
in response to an adjustment operation on the edge region, displaying a target edge region adjusted on the region configuration page; in response to a trigger operation on a save item in the region configuration page, synchronizing the target edge region to a detection device providing the detection information;
obtaining a trigger operation on a currently selected region in the region configuration page, displaying a property configuration page for the currently selected region, the property configuration page comprising a region adjustment item, and in response to a trigger operation on the region adjustment item, displaying a property selection page corresponding to the region adjustment item, obtaining property configuration information selected in the property selection page, and applying the property configuration information to the currently selected region;
selecting an arbitrary region within a spatial region in the region configuration page to generate a customized monitoring region, the spatial region is a region corresponding to the target space in the region configuration page; in response to a selection operation on the customized monitoring region, displaying a function configuration page for a selected monitoring region, obtaining control attribute information configured in the function configuration page, and generating an automated control scheme for each monitoring region; wherein a configured monitoring region and an configured edge region are configured to implement automated control via region based detection.

11. The method of claim 9, wherein before displaying the edge region on the region configuration page, the method comprises:
obtaining the detection information collected by a detection device based on a detection instruction, while the first target object moves in the target space, wherein the detection instruction is generated in response to a trigger operation on the edge configuration item in the region configuration page;
based on the detection information, determining a position of the first target object in the target space and a position of a ghost target corresponding to the first target object;
based on the position of the first target object and the position of the ghost target, determining the edge region corresponding to the target space, wherein the edge region is automatically displayed on the region configuration page in response to the trigger operation on the edge configuration item.

12. The method of claim 11, wherein said determining the position of the first target object in the target space and the position of the ghost target corresponding to the first target object based on the detection information, comprises:
identifying positions of targets in the target space based on the detection information, the targets comprising the first target object and the ghost target;
determining distances between the targets and the detection device based on the positions of the targets;
determining the first target object in the target space and the ghost target corresponding to the first target object, based on the distances between the targets and the detection device, to obtain the position of the first target object and the position of the ghost target;
wherein determining the first target object in the target space and the ghost target corresponding to the first target object based on the distances between the targets and the detection device, comprises:
determining a target having the smallest distance to the detection device as the first target object;
determining each target other than the first target object as the ghost target corresponding to the first target object.

13. A spatial configuration method, executed by an electronic device, comprising:
displaying a spatial configuration page; the spatial configuration page comprising a spatial region; wherein the spatial region includes a region from a spatial layout diagram corresponding to a target space, the spatial layout diagram is obtained from trajectory information of a first target object within each space of the target space and an entrance and exit position of each space, the spatial layout diagram is configured to display previously added second target objects at corresponding positions;
displaying a generated device control scheme in a scheme presentation area of the spatial configuration page; wherein a device control scheme is generated by matching relationships among second target objects in the target space;
in response to a save operation on a selected device control scheme, generating an intelligent space template based on the device control scheme; wherein the intelligent space template is configured for application to spaces compatible with the target space.

14. The method of claim 13, wherein displaying the generated device control scheme in the scheme presentation area of the spatial configuration page comprises:
obtaining historical control data of each second target object;
determining trigger conditions and execution actions corresponding to each second target object having a linkage relationship in the target space, based on positional relationships among the second target objects, device relationships among the second target objects, and the historical control data;
generating the device control scheme corresponding to each spatial region based on the trigger conditions and execution actions corresponding to each second target object.

15. The method of claim 13, wherein after generating the intelligent space template, the method comprises:
obtaining a geographical position corresponding to the target space;
sharing the intelligent space template to a spatial template collection corresponding to the geographical position; wherein the spatial template collection is configured to push each intelligent space template within the spatial template collection to a target terminal satisfying a push condition, based on the geographical position;
wherein the intelligent space template is configured to recommend a template to the target terminal satisfying the push condition based on the geographical position of the target space, so as to instruct the target terminal to display a recommended intelligent space template based on a current geographical position for application; each intelligent space template comprises spatial regions of a template space and device control schemes adapted for the second target object deployable in the template space.

16. The method of claim 13, wherein after generating the intelligent space template, the method further comprises:
displaying a template recommendation page, and presenting at least one intelligent space template recommended based on a current geographical position on the template recommendation page; the intelligent space template comprising a functional region of a target space matching a geographical position of the template space, a device deployable in the template space, and a device control service provided for the device deployable in the template space;
in response to a selection operation on the intelligent space template, displaying a template editing page corresponding to a selected intelligent space template; wherein the template editing page is configured to edit functional regions, devices, and device control services within the selected intelligent space template;
in response to a save operation on an edited intelligent space template, applying the edited intelligent space template to the template space.

17. The method of claim 16, wherein displaying the template recommendation page comprises at least one of:
recommending at least one configuration dataset based on the current geographical position, so as to display at least one intelligent space template recommended based on the current geographical position, on the template recommendation page, based on the configuration dataset; recommending at least one configuration dataset based on the current geographical position, comprising: obtaining the geographical position of the template space; requesting recommendations for the target space based on the geographical position to obtain recommended spatial data; obtaining the configuration dataset based on the recommended spatial data, device data associated with the recommended spatial data, and scene linkage data;
recommending at least one configuration dataset, based on the functional region of the template space, so as to display the functional region of the template space, as well as at least one intelligent space template recommended based on the configuration dataset, on the template recommendation page; recommending at least one configuration dataset based on functional region in the template space, comprising: obtaining a functional tag of the functional region of the template space; based on the functional tag, searching a first candidate space within the target space, and a functional region of the first candidate is similar to the functional region of the template space; acting spatial data of the first candidate space, together with the device data and the scene linkage data associated with the spatial data of the first candidate space, as the configuration dataset;
recommending at least one configuration dataset based on a device deployed in the template space, so as to display the device deployed in the template space, as well as at least one intelligent space template recommended based on the configuration dataset, on the template recommendation page; recommending at least one configuration dataset based on the device deployed in the template space comprising: obtaining target device data of the template space; the target device data indicating a device already deployed in the template space; based on the target device data, searching the target space for a second candidate space whose deployed device is similar to the device already deployed in the template space; acting the spatial data of the second candidate space, the device data associated with the spatial data of the second candidate space, and the scene linkage data as the configuration dataset;
recommending at least one configuration dataset based on a device usage habit in the template space, so as to display the device usage habit in the template space, as well as at least one intelligent space template recommended based on the configuration dataset, on the template recommendation page; recommending at least one configuration dataset based on the device usage habit in the template space comprising: obtaining device usage data for the template space; the device usage data describing the device usage habit of a user in the template space; searching for the target space for a third candidate space whose device usage habit is similar to the device usage habits in the template space, based on the device usage data; acting the spatial data of the third candidate space, the device data associated with the spatial data of the third candidate space, and the scene linkage data as the configuration dataset.

18. The method of claim 16, after displaying the template recommendation page, the method further comprising:
in response to a region editing operation on a functional region displayed on the template recommendation page, displaying a region editing entry corresponding to the functional region on the template recommendation page; the region editing entry comprising at least one of a functional tag entry and a sensitivity entry; when a tag editing operation on the functional tag entry is detected, displaying the functional region on the template recommendation page based on an edited functional tag; when a sensitivity editing operation on the sensitivity entry is detected, adjusting region monitoring sensitivity of the functional region; the region monitoring sensitivity indicating monitoring sensitivity of a corresponding device for the functional region.

19. The method of claim 16, after displaying the template recommendation page, the method further comprising:
in response to a region addition operation triggered in any blank display area of the template recommendation page, displaying an added functional region in the blank display area of the template recommendation page; obtaining a configuration operation on the added functional region and displaying a region configuration page corresponding to the functional region; in response to configuration data configured in the region configuration page, generating the device control service for the functional region.

20. An electronic device comprising at least one processor and at least one memory, wherein the memory stores computer readable instructions; when executed by one or more of the processors, the computer readable instructions implement the spatial configuration method of claim 1.
